(19) United States
(12) Patent Application Publication
(10) Pub. No.: US 2026/0235909 A1
(43) Pub. Date: Aug. 13, 2026

(54) ILLUMINATION SYSTEM AND ILLUMINATION DEVICE

(71) Applicant: Japan Display Inc., Tokyo (JP)

(72) Inventor: Gang SHAO, Tokyo (JP)

(21) Appl. No.: 19/640,660

(22) Filed: Apr. 7, 2026

Related U.S. Application Data
(63) Continuation of application No. PCT/JP2024/029625, filed on Aug. 21, 2024.

(30) Foreign Application Priority Data
Oct. 10, 2023 (JP) 2023-175485

(51) Int. Cl. G02F 1/1335; G02F 1/13357; G06F 3/16

(52) U.S. Cl. CPC G02F 1/133612; G02F 1/133553; G02F 1/133603; G06F 3/162

(57) ABSTRACT

According to an aspect, an illumination system includes: a speaker device capable of playing music data; an illumination device capable of controlling a light distribution state of light emitted from a light source; and a control device configured to transmit the music data to the speaker device and dynamically control the light distribution state of the illumination device in synchronization with a time-series change of the music data.

### CROSS-REFERENCE TO RELATED APPLICATION

This application claims the benefit of priority from Japanese Patent Application No. 2023-175485 filed on Oct. 10, 2023 and International Patent Application No. PCT/JP2024/029625 filed on Aug. 21, 2024, the entire contents of which are incorporated herein by reference.

### BACKGROUND

### 1. Technical Field

What is disclosed herein relates to an illumination system and an illumination device.

### 2. Description of the Related Art

In a conventional illumination instrument, a light source such as an LED is combined with a thin lens provided with a prism pattern, and the distance between the light source and the thin lens is changed to change light spread (hereinafter also referred to as “light distribution”). For example, an illumination instrument is disclosed in which the front of a transparent light bulb is covered by a liquid crystal light adjustment element, and the transmittance of a liquid crystal layer is changed to switch between directly-reaching light and scattering light (for example, refer to Japanese Patent Application Laid-open Publication No. H02-65001). For example, an illumination control device is disclosed that changes brightness of illumination over time to reproduce fluctuating light such as a candle flame (for example, refer to Japanese Patent Application Laid-open Publication No. 2009-004329).

The 1/f fluctuation in which regularity and irregularity are harmonized is a phenomenon universally found in nature, such as a candle flame and a murmuring stream, and can provide psychological comfort. A psychological effect due to such fluctuation is also observed in an audio signal such as music. For example, an illumination device capable of controlling light distribution is desired to be able to produce fluctuation of an audio signal.

For the foregoing reasons, there is a need for an illumination system and an illumination device that can achieve dynamic light distribution control that follows a signal level of music data.

### SUMMARY

According to an aspect, an illumination system includes: a speaker device capable of playing music data; an illumination device capable of controlling a light distribution state of light emitted from a light source; and a control device configured to transmit the music data to the speaker device and dynamically control the light distribution state of the illumination device in synchronization with a time-series change of the music data.

According to an aspect, an illumination system includes: an illumination device capable of controlling a light distribution state of light emitted from a light source; and a control device configured to control the light distribution state of the illumination device. The illumination device includes a speaker configured to play music data transmitted from the control device, and the control device transmits the music data to the illumination device and dynamically controls the light distribution state of the illumination device in synchronization with a time-series change of the music data.

According to an aspect, an illumination system includes: an illumination device capable of controlling a light distribution state of light emitted from a light source; and a control device configured to play music data and dynamically control the light distribution state of the illumination device in synchronization with a time-series change of the music data.

According to an aspect, an illumination device includes: a speaker capable of playing music data; an optical element capable of controlling a light distribution state of light emitted from a light source; a processing circuit configured to perform light distribution control of the optical element; and a storage circuit storing the music data and light distribution data synchronized with a time-series change of the music data. The processing circuit is configured to perform light distribution control of the optical element based on the light distribution data.

### BRIEF DESCRIPTION OF THE DRAWINGS

FIG. 1A is a side view illustrating an example of an illumination device according to an embodiment;

FIG. 1B is a perspective view illustrating an example of an optical element according to the embodiment;

FIG. 2 is a schematic plan view of a first substrate when viewed in a Dz direction;

FIG. 3 is a schematic plan view of a second substrate when viewed in the Dz direction;

FIG. 4 is a see-through diagram of a liquid crystal cell in which the first substrate and the second substrate are stacked in the Dz direction;

FIG. 5 is a sectional view along line A-A′ illustrated in FIG. 4;

FIG. 6A is a diagram illustrating the alignment direction of an alignment film of the first substrate;

FIG. 6B is a diagram illustrating the alignment direction of an alignment film of the second substrate;

FIG. 7 is a multilayered structure diagram of the optical element according to the embodiment;

FIG. 8A is a conceptual diagram for description of changes in shape of light by the optical element according to the embodiment;

FIG. 8B is a conceptual diagram for description of changes in shape of light by the optical element according to the embodiment;

FIG. 8C is a conceptual diagram for description of changes in shape of light by the optical element according to the embodiment;

FIG. 8D is a conceptual diagram for description of changes in shape of light by the optical element according to the embodiment;

FIG. 9 is a conceptual diagram for conceptually describing light distribution control by the illumination device according to the embodiment;

FIG. 10 is a diagram illustrating a schematic configuration of an illumination system according to a first embodiment;

FIG. 11 is a block diagram illustrating an example of a control device according to the first embodiment;

FIG. 12 is a conceptual diagram for description of an example of light distribution data generation;

FIG. 13A is a flowchart illustrating a first example of a light distribution data generation process according to the embodiment;

FIG. 13B is a flowchart illustrating a second example of the light distribution data generation process according to the embodiment;

FIG. 13C is a flowchart illustrating a third example of the light distribution data generation process according to the embodiment;

FIG. 13D is a flowchart illustrating a fourth example of the light distribution data generation process according to the embodiment;

FIG. 14 is a block diagram illustrating an example of the illumination device according to the first embodiment;

FIG. 15 is a block diagram illustrating an example of a speaker device according to the first embodiment;

FIG. 16A is a flowchart illustrating a first example of a music-following light distribution control process according to the first embodiment;

FIG. 16B is a flowchart illustrating a second example of the music-following light distribution control process according to the first embodiment;

FIG. 16C is a flowchart illustrating a third example of the music-following light distribution control process according to the first embodiment;

FIG. 17 is a block diagram illustrating an example of an illumination device according to a second embodiment;

FIG. 18 is a block diagram illustrating an example of a speaker device according to the second embodiment;

FIG. 19A is a flowchart illustrating a first example of the music-following light distribution control process according to the second embodiment;

FIG. 19B is a flowchart illustrating a second example of the music-following light distribution control process according to the second embodiment;

FIG. 19C is a flowchart illustrating a third example of the music-following light distribution control process according to the second embodiment;

FIG. 20 is a flowchart illustrating a music-following light distribution control process according to a modification of the second embodiment;

FIG. 21 is a diagram illustrating a schematic configuration of an illumination system according to a third embodiment;

FIG. 22 is a block diagram illustrating an example of an illumination device according to the third embodiment;

FIG. 23 is a block diagram illustrating an example of an illumination device according to a fourth embodiment;

FIG. 24 is a diagram illustrating a schematic configuration of an illumination system according to a fifth embodiment; and

FIG. 25 is a block diagram illustrating an example of a control device according to the fifth embodiment.

### DETAILED DESCRIPTION

Aspects (embodiments) of the present disclosure will be described below in detail with reference to the accompanying drawings. Contents described below in the embodiments do not limit the present disclosure. Components described below include those that could be easily thought of by the skilled person in the art and those identical in effect. Components described below may be combined as appropriate. What is disclosed herein is merely exemplary, and any modification that could be easily thought of by the skilled person in the art as appropriate without departing from the gist of the disclosure is contained in the scope of the present disclosure. For clearer description, the drawings are schematically illustrated for the width, thickness, shape, and the like of each component as compared to an actual aspect in some cases, but the drawings are merely exemplary and do not limit interpretation of the present disclosure. In the present specification and drawings, any element same as that already described with reference to an already described drawing is denoted by the same reference sign, and detailed description thereof is omitted as appropriate in some cases.

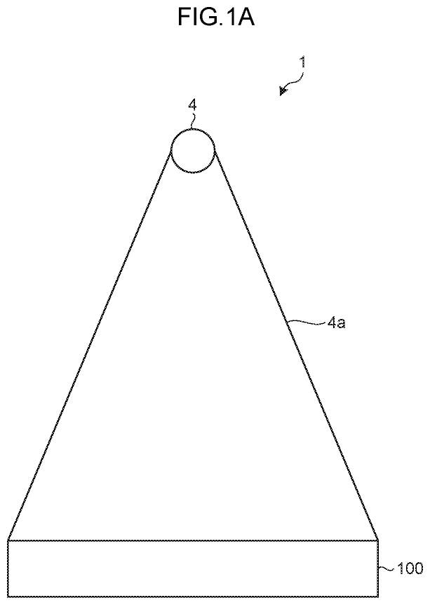

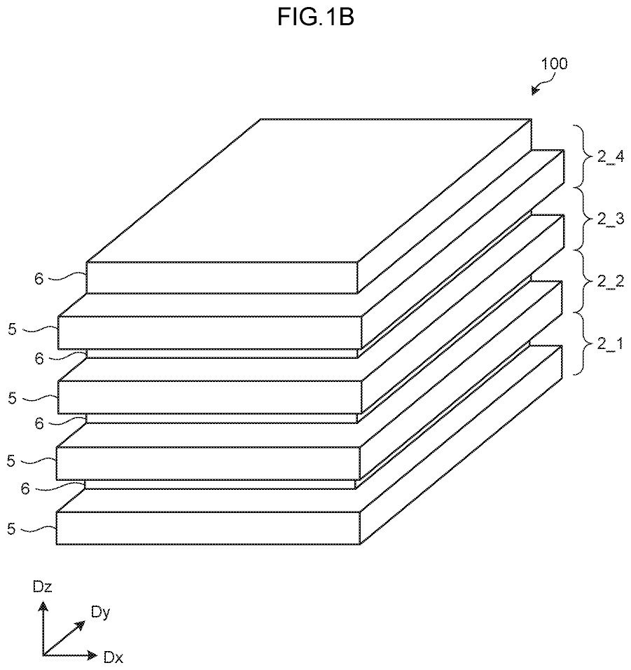

FIG. 1A is a side view illustrating an example of an illumination device according to an embodiment. FIG. 1B is a perspective view illustrating an example of an optical element according to the embodiment. As illustrated in FIG. 1A, the illumination device 1 includes a light source 4, a reflector 4a, and an optical element 100. As illustrated in FIG. 1B, the optical element 100 includes a first liquid crystal cell 2_1, a second liquid crystal cell 2_2, a third liquid crystal cell 2_3, and a fourth liquid crystal cell 2_4. The light source 4 is configured with, for example, a light emitting diode (LED). The reflector 4a is a component that condenses light from the light source 4 to the optical element 100.

In FIG. 1B, a Dz direction indicates the emission direction of light from the light source 4 and the reflector 4a. The optical element 100 has a configuration in which the first liquid crystal cell 2_1, the second liquid crystal cell 2_2, the third liquid crystal cell 2_3, and the fourth liquid crystal cell 2_4 are stacked in the Dz direction. In the present disclosure, the optical element 100 has a configuration in which the first liquid crystal cell 2_1, the second liquid crystal cell 2_2, the third liquid crystal cell 2_3, and the fourth liquid crystal cell 2_4 are sequentially stacked from the light source 4 side (lower side in FIG. 1B). In FIG. 1B, one direction in a plane orthogonal to the Dz direction and parallel to stacking surfaces of the first liquid crystal cell 2_1, the second liquid crystal cell 2_2, the third liquid crystal cell 2_3, and the fourth liquid crystal cell 2_4 is defined as a Dx direction (first direction), and a direction orthogonal to both the Dx direction and the Dz direction is defined as a Dy direction (second direction).

The first liquid crystal cell 2_1, the second liquid crystal cell 2_2, the third liquid crystal cell 2_3, and the fourth liquid crystal cell 2_4 have the same configuration. In the present disclosure, the first liquid crystal cell 2_1 and the fourth liquid crystal cell 2_4 are liquid crystal cells for p-wave polarization. The second liquid crystal cell 2_2 and the third liquid crystal cell 2_3 are liquid crystal cells for s-wave polarization. Hereinafter, the first liquid crystal cell 2_1, the second liquid crystal cell 2_2, the third liquid crystal cell 2_3, and the fourth liquid crystal cell 2_4 are also collectively referred to as “liquid crystal cells 2”.

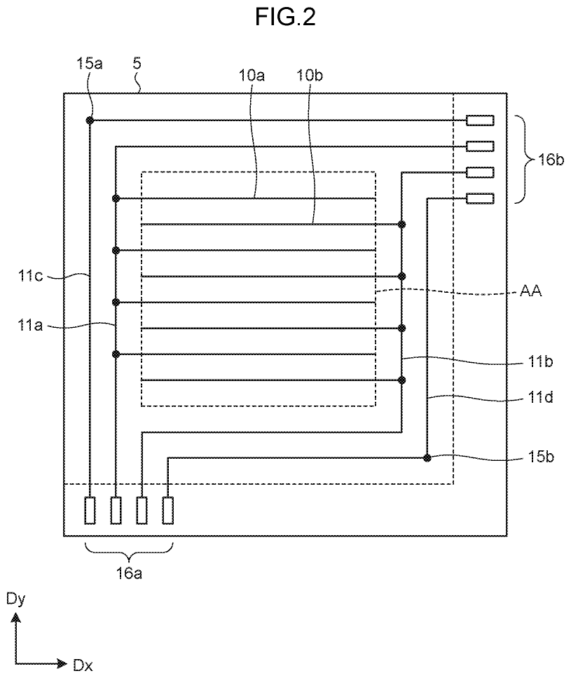

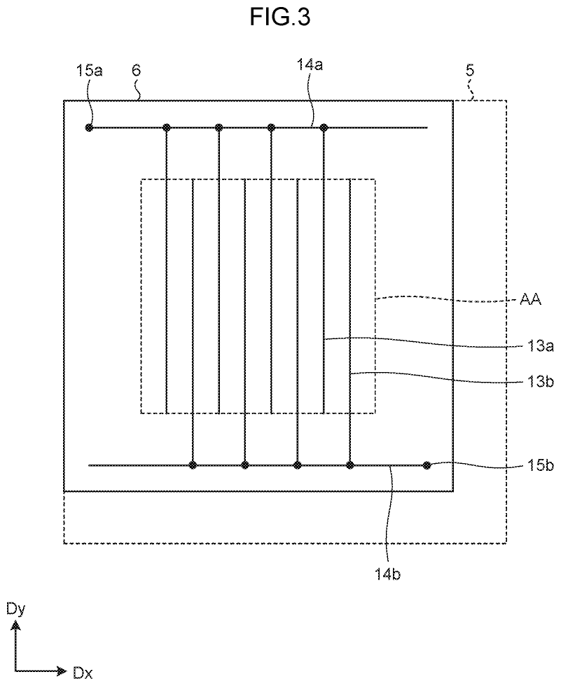

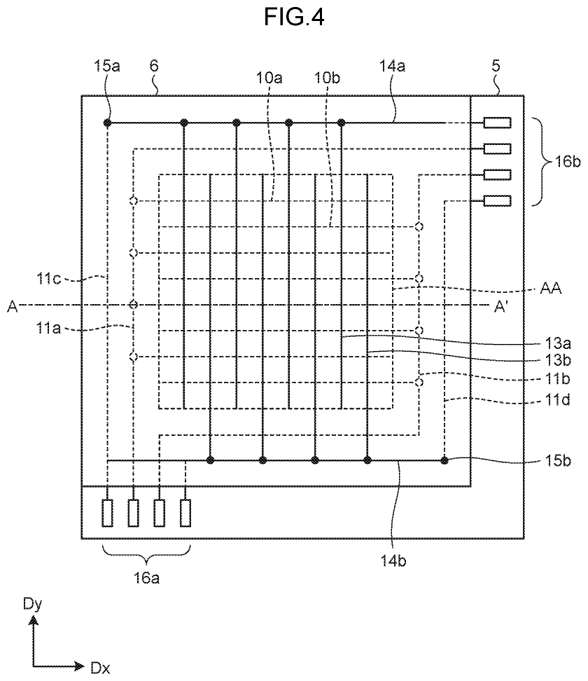

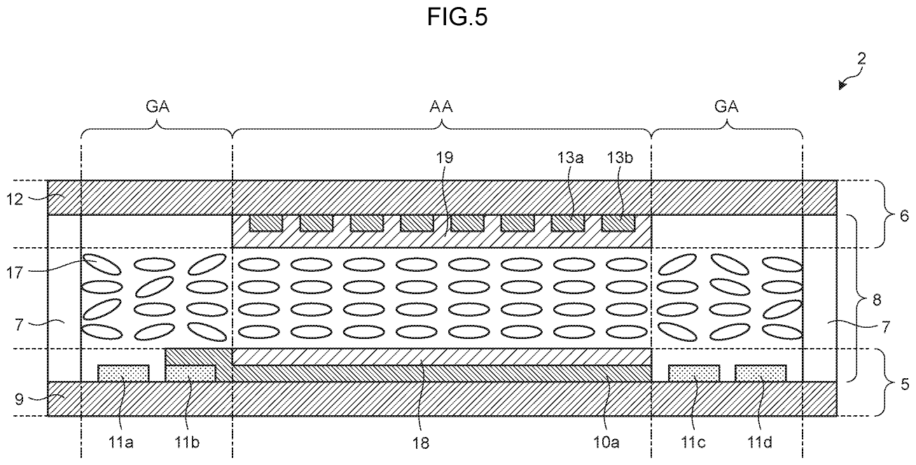

Each liquid crystal cell 2 includes a first substrate 5 and a second substrate 6. FIG. 2 is a schematic plan view of the first substrate when viewed in the Dz direction. FIG. 3 is a schematic plan view of the second substrate when viewed in the Dz direction. In FIG. 3, drive electrodes are visible through the substrates, but for clarity, the drive electrodes and wiring lines are illustrated with solid lines. FIG. 4 is a see-through diagram of a liquid crystal cell in which the first substrate and the second substrate are stacked in the Dz direction. In FIG. 4 as well, for clarity, the drive electrodes and wiring lines on the second substrate side are illustrated with solid lines, and drive electrodes and wires on the first substrate side are illustrated with dotted lines. FIG. 5 is a sectional view along line A-A′ illustrated in FIG. 4. FIGS. 2, 3, 4, and 5 exemplarily illustrate the third liquid crystal cell 2_3 and the fourth liquid crystal cell 2_4 in which drive electrodes 10a and 10b of the first substrate 5 extend in the Dx direction and drive electrodes 13a and 13b of the second substrate 6 extend in the Dy direction.

As illustrated in FIG. 5, the liquid crystal cell 2 includes a liquid crystal layer 8 sealed around its periphery by a sealing member 7 between the first substrate 5 and the second substrate 6.

The liquid crystal layer 8 modulates light passing through the liquid crystal layer 8 in accordance with the state of electric field. As liquid crystal molecules, positive-type nematic liquid crystals are used, but other liquid crystals with the same effects may be used.

As illustrated in FIG. 2, the drive electrodes 10a and 10b, metal lines 11a and 11b, and metal lines 11c and 11d are provided on the liquid crystal layer 8 side of a base member 9 of the first substrate 5. The metal lines 11a and 11b supply drive voltage that is applied to the drive electrodes 10a and 10b, and the metal lines 11c and 11d supply drive voltage that is applied to the drive electrodes 13a and 13b (refer to FIG. 3) provided on the second substrate 6 to be described later. The metal lines 11a, 11b, 11c, and 11d are provided in a wiring layer of the first substrate 5. The metal lines 11a, 11b, 11c, and 11d are provided to be spaced apart from each other in the wiring layer on the first substrate 5. Hereinafter, the drive electrodes 10a and 10b are simply referred to as “drive electrodes 10” in some cases. The metal lines 11a, 11b, 11c, and 11d are referred to as “first metal lines 11” in some cases. As illustrated in FIG. 2, in the third liquid crystal cell 2_3 and the fourth liquid crystal cell 2_4, the drive electrodes 10 on the first substrate 5 extend in the Dx direction. In the first liquid crystal cell 2_1 and the second liquid crystal cell 2_2, the drive electrodes 10 on the first substrate 5 extend in the Dy direction.

As illustrated in FIG. 3, the drive electrodes 13a and 13b, and metal lines 14a and 14b that supply drive voltage applied to the drive electrodes 13 are provided on the liquid crystal layer 8 side of a base member 12 of the second substrate 6 illustrated in FIG. 5. The metal lines 14a and 14b are provided in a wiring layer of the second substrate 6. The metal lines 14a and 14b are provided to be spaced apart from each other in the wiring layer on the second substrate 6. Hereinafter, the drive electrodes 13a and 13b are simply referred to as “drive electrodes 13” in some cases. The metal lines 14a and 14b are referred to as “second metal lines 14” in some cases. As illustrated in FIG. 3, in the third liquid crystal cell 2_3 and the fourth liquid crystal cell 2_4, the drive electrodes 13 on the second substrate 6 extend in the Dy direction. In the first liquid crystal cell 2_1 and the second liquid crystal cell 2_2, the drive electrodes 13 on the second substrate 6 extend in the Dx direction.

The drive electrodes 10 and 13 are light-transmitting electrodes formed of a light-transmitting conductive material (light-transmitting conductive oxide) such as indium tin oxide (ITO). The first substrate 5 and the second substrate 6 are light-transmitting substrates of glass, resin, or the like. The first metal lines 11 and the second metal lines 14 are formed of at least one metallic material among aluminum (Al), copper (Cu), silver (Ag), molybdenum (Mo), and alloy thereof. The first metal lines 11 and the second metal lines 14 may be each formed of one or more of these metallic materials as a multilayered body of a plurality of layers. The at least one metallic material among aluminum (Al), copper (Cu), silver (Ag), molybdenum (Mo), and alloy thereof has a resistance lower than that of light-transmitting conductive oxide such as ITO.

The metal line 11c of the first substrate 5 and the metal line 14a of the second substrate 6 are coupled by a conduction part 15a formed with, for example, conductive paste. The metal line 11d of the first substrate 5 and the metal line 14b of the second substrate 6 are coupled by a conduction part 15b formed with, for example, conductive paste.

Coupling (flex-on-board) terminal parts 16a and 16b that are coupled to non-illustrated flexible printed circuits (FPC) are provided in regions on the first substrate 5, which do not overlap the second substrate 6 when viewed in the Dz direction. The coupling terminal parts 16a and 16b each include four coupling terminals corresponding to the metal lines 11a, 11b, 11c, and 11d, respectively.

The coupling terminal parts 16a and 16b are provided in the wiring layer of the first substrate 5. Drive voltage to be applied to the drive electrodes 10a and 10b on the first substrate 5 and to the drive electrodes 13a and 13b on the second substrate 6 is supplied to the liquid crystal cell 2 from an FPC coupled to the coupling terminal part 16a or the coupling terminal part 16b. Hereinafter, the coupling terminal parts 16a and 16b are simply referred to as “coupling terminal parts 16” in some cases.

As illustrated in FIG. 4, in the liquid crystal cell 2, the first substrate 5 and the second substrate 6 are arranged in the Dz direction (irradiation direction of light), and the drive electrodes 10 on the first substrate 5 intersect the drive electrodes 13 on the second substrate 6 when viewed in the Dz direction. In the liquid crystal cell 2 thus configured, the alignment direction of liquid crystal molecules 17 in the liquid crystal layer 8 can be controlled by supplying drive voltage to the drive electrodes 10 on the first substrate 5 and the drive electrodes 13 on the second substrate 6. A region in which the alignment direction of the liquid crystal molecules 17 in the liquid crystal layer 8 can be controlled is referred to as an “effective region AA”. The refractive index distribution of the liquid crystal layer 8 is changed in the effective region AA, whereby the diffusion degree of light transmitted through the effective region AA of the liquid crystal cell 2 can be controlled. A region outside the effective region AA, where the liquid crystal layer 8 is sealed by the sealing member 7, is referred to as a “peripheral region GA” (refer to FIG. 5).

As illustrated in FIG. 5, the drive electrodes 10 (in FIG. 5, the drive electrode 10a) in the effective region AA of the first substrate 5 are covered by an alignment film 18. The drive electrodes 13 (in FIG. 5, the drive electrodes 13a and 13b) in the effective region AA of the second substrate 6 are covered by an alignment film 19. The alignment direction of the liquid crystal molecules is different between the alignment film 18 and the alignment film 19.

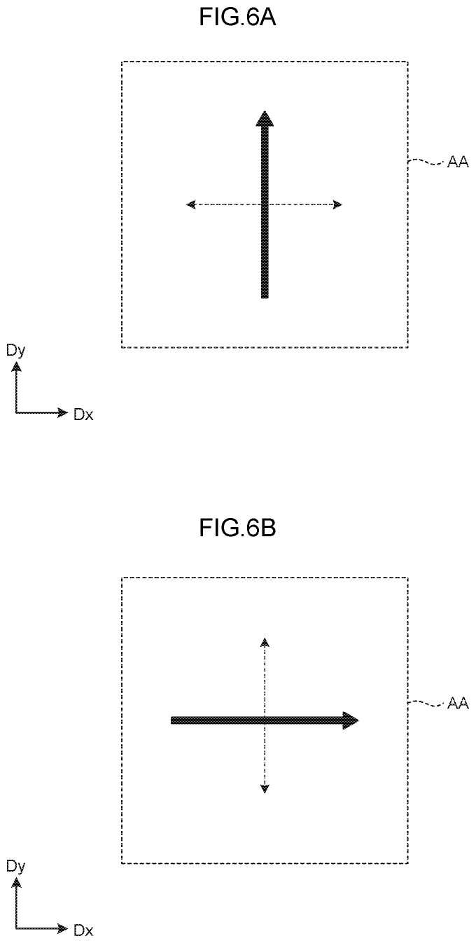

FIG. 6A is a diagram illustrating the alignment direction of the alignment film of the first substrate. FIG. 6B is a diagram illustrating the alignment direction of the alignment film of the second substrate.

As illustrated in FIGS. 6A and 6B, the alignment direction of the alignment film 18 of the first substrate 5 and the alignment direction of the alignment film 19 of the second substrate 6 are directions intersecting each other in plan view. Specifically, as illustrated with a solid arrow in FIG. 6A, the alignment direction of the alignment film 18 of the first substrate 5 is orthogonal to the extending direction of the drive electrodes 10a and 10b, which is illustrated with a dashed arrow in FIG. 6A. As illustrated with a solid arrow in FIG. 6B, the alignment direction of the alignment film 19 of the second substrate 6 is orthogonal to the extending direction of the drive electrodes 13a and 13b, which is illustrated with a dashed arrow in FIG. 6B. In the following description, the extending directions of the drive electrodes 10 and 13 are orthogonal to the alignment directions of the alignment films 18 and 19 covering them, but these may intersect at an angle other than being orthogonal, for example, in the angle range of 85° to 90°. The drive electrodes 10 on the first substrate 5 side and the drive electrodes 13 on the second substrate 6 side are preferably orthogonal to each other but may intersect, for example, in the angle range of 85° to 90°. The alignment directions of the alignment films 18 and 19 are formed by rubbing processing or light alignment processing.

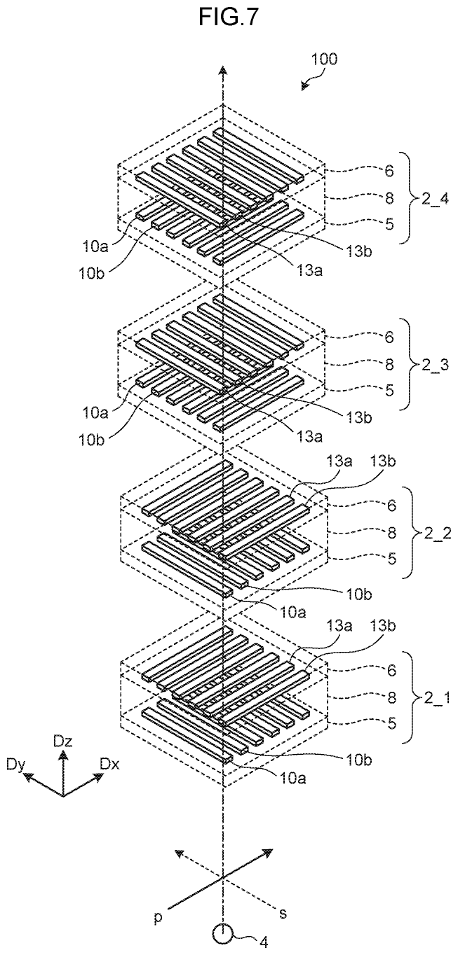

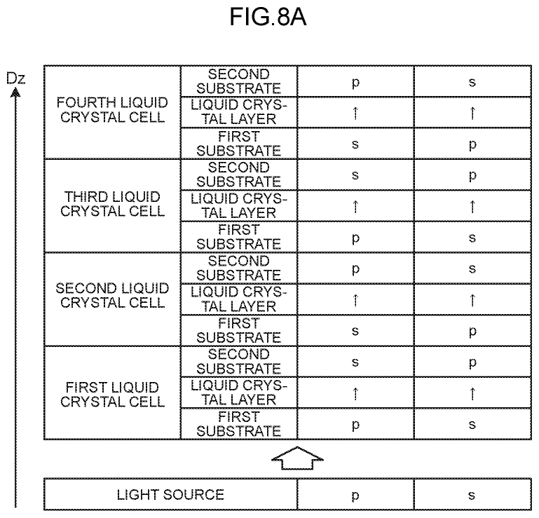

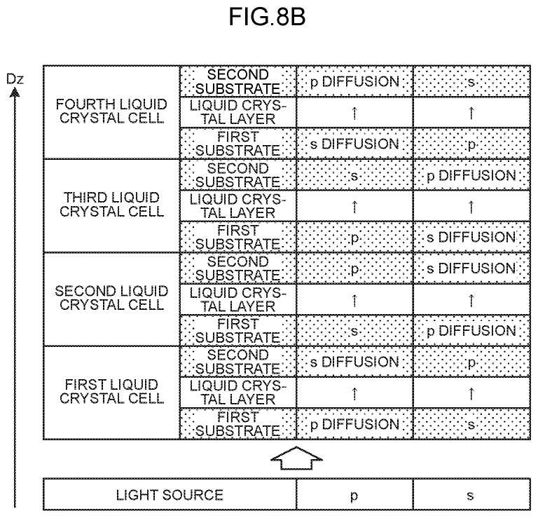

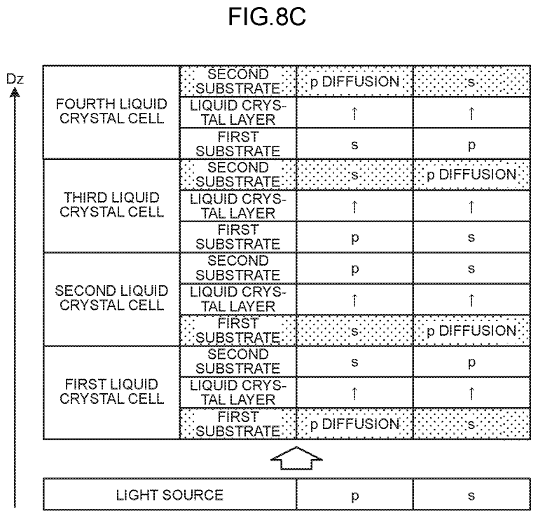

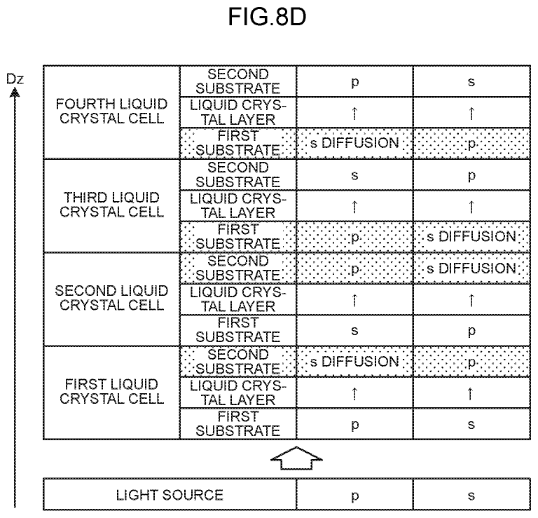

A mechanism for changing the shape of light by using the liquid crystal cells 2 (the first liquid crystal cell 2_1, the second liquid crystal cell 2_2, the third liquid crystal cell 2_3, and the fourth liquid crystal cell 2_4) will be described below. FIG. 7 is a multilayered structure diagram of the optical element according to the embodiment. FIGS. 8A, 8B, 8C, and 8D are conceptual diagrams for describing changes in shape of light by the optical element according to the embodiment. FIGS. 8A, 8B, 8C, and 8D illustrate examples in which potential difference is generated between the drive electrodes of hatched substrates of the liquid crystal cells 2.

As illustrated in FIG. 7, the optical element 100 is provided on the optical axis of the light source 4, which is illustrated with a dashed and single-dotted line, and as described above, the first liquid crystal cell 2_1, the second liquid crystal cell 2_2, the third liquid crystal cell 2_3, and the fourth liquid crystal cell 2_4 are sequentially stacked from the light source 4 side (lower side in FIG. 7). The third liquid crystal cell 2_3 and the fourth liquid crystal cell 2_4 are stacked in a state of being rotated by 90° relative to the first liquid crystal cell 2_1 and the second liquid crystal cell 2_2.

In each liquid crystal cell 2, the alignment direction of the alignment film on the first substrate 5 side and the second substrate 6 side intersect each other as illustrated in FIGS. 6A and 6B. Accordingly, from the first substrate 5 side toward the second substrate 6 side, the orientation of the liquid crystal molecules in the liquid crystal layer 8 gradually changes from the Dx direction to the Dy direction (or from the Dy direction to the Dx direction), and the polarized component of transmitted light rotates along with the change. Specifically, in the liquid crystal cell 2, the polarized component, which is a p-polarized component on the first substrate 5 side, changes to an s-polarized component as distance from the second substrate 6 decreases; and the polarized component, which is an s-polarized component on the first substrate 5 side, changes to a p-polarized component as distance from the second substrate 6 decreases. This rotation of the polarized component may be referred to as optical rotation.

FIG. 8A illustrates a state in which no potential is generated between adjacent electrodes in each liquid crystal cell 2. In this case, only optical rotation occurs in each liquid crystal cell 2 and no polarized component is diffused.

As illustrated in FIG. 8B, for example, when potential difference is generated between the drive electrodes 10a and 10b on the first substrate 5 in the first liquid crystal cell 2_1, the liquid crystal molecules between the electrodes are aligned in a circular arc shape, and thus, refractive index distribution is formed in the Dx direction in the liquid crystal layer 8. As light from the light source 4 is transmitted in this state, the above-described refractive index distribution acts on the polarized component (in FIG. 8B, p-polarized component) parallel to the Dx direction, and therefore, the p-polarized component diffuses in the Dx direction.

In addition, when potential difference is generated between the drive electrodes 13a and 13b on the second substrate 6 side in the first liquid crystal cell 2_1, refractive index distribution is formed in the Dy direction on the second substrate 6 side, and accordingly, the s-polarized component diffuses in the Dy direction on the second substrate 6 side. Specifically, the polarized component having changed from a p-polarized component to an s-polarized component during passing through the liquid crystal layer 8 in the first liquid crystal cell 2_1 diffuses in the Dy direction as well. However, the s-polarized component at incidence on the first liquid crystal cell 2_1 optically rotates during passing through the liquid crystal layer 8 but intersects each refractive index distribution, and accordingly, only optically rotates without diffusing and passes through the first liquid crystal cell 2_1.

The s-polarized component at incidence on the first liquid crystal cell 2_1 changes to a p-polarized component after passing through the first liquid crystal cell 2_1, and the second liquid crystal cell 2_2 acts on this p-polarized component. Specifically, as illustrated in FIGS. 8A and 8B, the first liquid crystal cell 2_1 acts on the p-polarized component of light incident on the optical element 100, and the second liquid crystal cell 2_2 acts on the s-polarized component thereof. Since the third liquid crystal cell 2_3 and the fourth liquid crystal cell 2_4 are provided with rotation by 90° relative to the first liquid crystal cell 2_1 and the second liquid crystal cell 2_2, polarized components on which they act are switched by 90°. Specifically, the third liquid crystal cell 2_3 acts on the s-polarized component at incidence on the optical element 100, and the fourth liquid crystal cell 2_4 acts on the p-polarized component at incidence on the optical element 100.

As illustrated in FIG. 8C, in the optical element, it is possible to act on the p-polarized component by providing potential difference between drive electrodes extending in the Dy direction in each liquid crystal cell 2 (between the drive electrodes 10a and 10b of the first substrate 5 in the first liquid crystal cell 2_1 and the second liquid crystal cell 2_2 and between the drive electrodes 13a and 13b of the second substrate 6 in the third liquid crystal cell 2_3 and the fourth liquid crystal cell 2_4), thereby increasing the shape of light mainly in the Dx direction. This effect may be referred to as horizontal diffusion.

As illustrated in FIG. 8D, it is possible to act on the s-polarized component by providing potential difference between drive electrodes extending in the Dx direction in each liquid crystal cell 2 (between the drive electrodes 13a and 13b of the second substrate 6 in the first liquid crystal cell 2_1 and the second liquid crystal cell 2_2 and between the drive electrodes 10a and 10b of the first substrate 5 in the third liquid crystal cell 2_3 and the fourth liquid crystal cell 2_4), thereby increasing the shape of light mainly in the Dy direction. This effect may be referred to as vertical diffusion.

The diffusion degree of light in each direction depends on the potential difference between the drive electrodes 10a and 10b (or between the drive electrodes 13a and 13b) adjacent to each other. The spread of light in the direction is maximum (100%) in a case where the potential difference between the drive electrodes 10a and 10b (or between the drive electrodes 13a and 13b) is maximum potential difference (for example, 30 V) defined in advance, and no spread of light (0%) occurs in the direction in a case where no potential difference is generated. Alternatively, the spread of light in the direction is 50% in a case where the potential difference between the drive electrodes 10a and 10b (or between the drive electrodes 13a and 13b) is 50% (for example, 15 V) of the above-described maximum potential difference. In a case where the relation between voltage difference and light spread is not linear, it is possible to set another potential difference instead of 15 V.

In each liquid crystal cell 2, the interval (also referred to as a cell gap) between its substrates (between the first substrate 5 and the second substrate 6) is large and is 30 μm to 50 μm approximately, and thus, influence of an electric field formed in one of the substrates on the other substrate side is reduced as much as possible. Drive voltage that generates potential difference between the drive electrodes 10a and 10b (or between the drive electrodes 13a and 13b) adjacent to each other is what is called an alternating-current square wave, thereby preventing burn-in of the liquid crystal molecules.

The alignment directions of the alignment films, the extending directions of the drive electrodes on the substrates, and the angle between them may be modified as appropriate for the entire optical element 100 or each liquid crystal cell 2 in accordance with the characteristics of liquid crystals to be employed and optical characteristics to be intentionally obtained.

In the present embodiment, description is made on the configuration of the optical element 100 in which the four liquid crystal cells of the first liquid crystal cell 2_1, the second liquid crystal cell 2_2, the third liquid crystal cell 2_3, and the fourth liquid crystal cell 2_4 are stacked, but the optical element 100 is not limited to this configuration and may employ, for example, a configuration in which two or three liquid crystal cells 2 are stacked or a configuration in which a plurality of liquid crystal cells 2, five or more liquid crystal cells 2, are stacked.

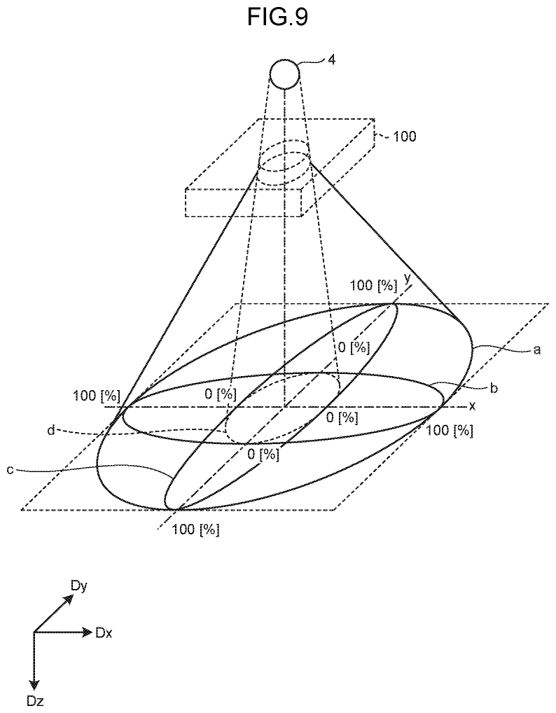

In the present disclosure, in the illumination device 1 with the above-described configuration, light incident on the optical element from the light source 4 is controlled in the two directions of the Dx direction (direction of horizontal diffusion) and the Dy direction (direction of vertical diffusion) by controlling drive voltage of each liquid crystal cell 2. The above-described vertical diffusion and horizontal diffusion may be collectively referred to as light diffusion. Accordingly, the shape of light emitted from the optical element is changed. The shape of light is a light shape that appears on a plane parallel to an emission surface of the optical element, and this may be referred to as a light distribution shape. Hereinafter, control of the light diffusion degree in the present disclosure will be described below with reference to FIG. 9.

FIG. 9 is a conceptual diagram for conceptually describing control of the light diffusion degree of the illumination device according to the embodiment. FIG. 9 illustrates an irradiation area of light on a virtual plane xy orthogonal to the Dz direction. The outline of the actual irradiation area is slightly unclear depending on the distance from the light source 4, a light diffraction phenomenon, and the like.

As described above, drive voltage is supplied to the drive electrodes 10 and 13 of each liquid crystal cell 2 of the optical element 100 provided on the optical axis of the light source 4, whereby the alignment direction of the liquid crystal molecules 17 in the liquid crystal layer 8 is controlled. With this control, the light distribution shape of light emitted from the optical element 100 is controlled.

Specifically, for example, the light distribution shape in the Dx direction changes depending on the drive voltage applied to the drive electrodes 10 or drive electrodes 13 extending in the Dy direction in each liquid crystal cell 2 as described above. Such light diffusion in the Dx direction may be referred to as horizontal diffusion. The light distribution shape in the Dy direction changes depending on the drive voltage applied to the drive electrodes 10 or drive electrodes 13 extending in the Dx direction in the first to fourth liquid crystal cells. Such light diffusion in the Dy direction may be referred to as vertical diffusion.

In the present disclosure, the minimum diffusion degrees of the horizontal diffusion and the vertical diffusion are 0% and the maximum diffusion degrees thereof are 100%. More specifically, in a case where the horizontal diffusion degree is 0%, drive electrodes (for example, the drive electrodes 10 extending in the Dy direction on the first substrate 5 in the first liquid crystal cell 2_1) functioning to expand the light distribution state in the Dx direction do not act on the refractive index distribution of the liquid crystal layer 8. In this case, no potential difference is present between the adjacent drive electrodes 10a and 10b or no potential is supplied to the electrodes. On the other hand, in a case where the horizontal diffusion degree is 100%, drive electrodes (for example, the drive electrodes 10 extending in the Dy direction on the first substrate 5 in the first liquid crystal cell 2_1) functioning to expand the light distribution state in the Dx direction maximally act on the refractive index distribution of the liquid crystal layer 8. In this case, the potential difference between the adjacent drive electrodes 10a and 10b is set to the maximum potential difference (for example, 30 V) in the optical element 100. In a case where the horizontal diffusion degree is larger than 0% and smaller than 100%, the potential adjusted such that the potential difference between the adjacent drive electrodes 10a and 10b is larger than 0 V and smaller than the maximum potential difference (for example, 30 V) is applied to the electrodes. The same applies to the vertical diffusion.

Outline “a” illustrated in FIG. 9 exemplarily indicates the irradiation area in a case where the horizontal diffusion degree and the vertical diffusion degree are both 100%. Outline “b” illustrated in FIG. 9 exemplarily indicates the irradiation area in a case where the horizontal diffusion degree is 100% and the vertical diffusion degree is 0%. Outline “c” illustrated in FIG. 9 exemplarily indicates the irradiation area in a case where the horizontal diffusion degree is 0% and the vertical diffusion degree is 100%. Outline “d” illustrated in FIG. 9 exemplarily indicates the irradiation area in a case where the horizontal diffusion degree and the vertical diffusion degree are both 0%. In other words, outline “d” indicates the light distribution state when light from the light source 4 is emitted without being controlled by the optical element 100 (or simply transmitted through the optical element 100).

In this manner, in the illumination device 1 with the above-described configuration, it is possible to control the horizontal and vertical diffusion degrees of emission light from the optical element 100 by performing drive voltage control of each liquid crystal cell 2. Accordingly, it is possible to change the light distribution shape of emission light from the illumination device 1. Hereinafter, control that changes the light distribution shape of emission light from the illumination device 1 is also referred to as “light distribution control”.

The illumination device 1 capable of light distribution control in the two directions of the Dx and Dy directions is exemplarily described in the present disclosure, but controllable parameters of the illumination device 1 is not limited to light distribution (light spread). For example, the illumination device 1 may be capable of light adjustment control. In this case, controllable parameters of the illumination device 1 may include light adjustment (brightness).

The following describes the configurations and operations of the illumination device 1 capable of light distribution control in the two directions of the Dx and Dy directions, in which a light distribution state in the two directions of the Dx and Dy directions can be dynamically controlled by following the signal level of music data.

In the following description, dynamic light distribution control following the signal level of music data is also referred to as “music-following light distribution control”. In addition, “dynamic light distribution control following the signal level of music data” in the present disclosure indicates control in which the light distribution shape changes with changes over time in the signal level of music data. In other words, “dynamic light distribution control following the signal level of music data” in the present disclosure indicates control in which the light distribution shape changes over time as the signal level of music data changes.

### First Embodiment

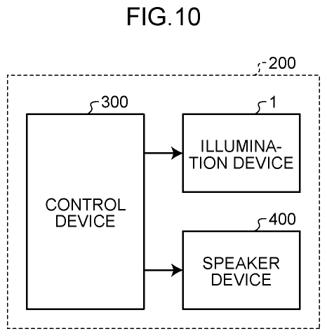

FIG. 10 is a diagram illustrating a schematic configuration of an illumination system 200 according to a first embodiment. As illustrated in FIG. 10, the illumination system 200 according to the first embodiment includes the illumination device 1, a control device 300, and a speaker device 400. The control device 300 is, for example, a portable communication terminal device such as a smartphone or a tablet. In the present disclosure, the illumination device 1 includes the optical element 100 described above and is configured to be able to control light distribution in the two directions of the Dx and Dy directions.

Data and various command signals are transmitted and received between the control device 300 and each of the illumination device 1 and the speaker device 400 through a communication means. In the present disclosure, the communication means is a wireless communication means of, for example, Bluetooth (registered trademark) or WiFi (registered trademark). Wireless communication may be performed between the control device 300 and each of the illumination device 1 and the speaker device 400 through, for example, a predetermined network such as a mobile communication network. Alternatively, the control device 300 and each of the illumination device 1 and the speaker device 400 may be coupled in a wired manner to perform wired communication.

In the present disclosure, the control device 300 has a function to generate light distribution data for the illumination device 1 from music data. The control device 300 transmits the light distribution data generated from the music data to the illumination device 1, and transmits the music data to the speaker device 400.

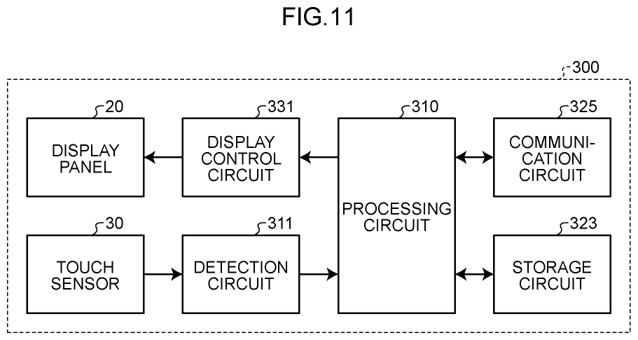

FIG. 11 is a block diagram illustrating an example of the control device 300 according to the first embodiment. As illustrated in FIG. 11, the control device 300 according to the first embodiment includes a display panel 20, a touch sensor 30, a processing circuit 310, a detection circuit 311, a storage circuit 323, a communication circuit 325, and a display control circuit 331. The control device 300 according to the first embodiment may include a power button and a mode selection switch.

The display control circuit 331 is a circuit that executes display control of the display panel 20. The detection circuit 311 is a circuit that detects the presence or absence of a touch on the touch sensor 30 based on a detection signal output from each detection element 31 of the touch sensor 30. The detection circuit 311 is configured with, for example, a detection IC. Alternatively, the detection circuit 311 and the display control circuit 331 may be mounted on the display panel 20 as one display IC.

The processing circuit 310 is configured with, for example, the CPU, RAM, EEPROM, and ROM of the smartphone or tablet constituting the control device 300. The display control circuit 331 may be a display IC mounted on the display panel 20 as described above, and moreover, may include, for example, the GPU of the smartphone or tablet constituting the control device 300.

The processing circuit 310 executes operation control of the illumination device 1 and the speaker device 400 based on a touch detection position in the detection circuit 311. In the present embodiment, the processing circuit 310 has a function to execute control software for starting or stopping a music-following light distribution control process. The processing circuit 310 is, for example, a component achieved by the CPU of the smartphone or tablet constituting the control device 300.

The storage circuit 323 is configured with, for example, the RAM, EEPROM, and ROM of the smartphone or tablet constituting the control device 300.

In the present disclosure, music data is stored in the storage circuit 323 in advance. In the present disclosure, examples of the music data include uncompressed sound source data such as RIFF waveform audio format (WAV), the music data is not limited thereto. The music data may be compressed sound source data such as Mpeg-1 Audio Layer-3 (MP3). The music data is format-converted into uncompressed pulse code modulation (PCM) data in a light distribution data generation process to be described later.

In the present disclosure, the storage circuit 323 stores light distribution data generated in the light distribution data generation process to be described later.

The communication circuit 325 is configured with, for example, a wireless communication module of the smartphone or tablet constituting the control device 300. The communication circuit 325 transmits light distribution data to the illumination device 1, and transmits music data to the speaker device 400.

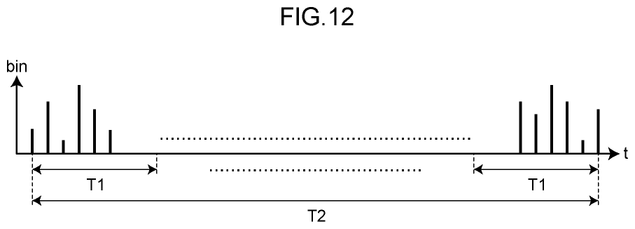

FIG. 12 is a conceptual diagram for description of an example of light distribution data generation. The following describes an example in which light distribution data is generated from uncompressed sound source data (binary data).

In the present disclosure, the processing circuit 310 of the control device 300 divides a music data length into a plurality of first periods T1 and generates light distribution data based on a representative value of the data values (binary data) of music data in each first period T1.

As a first example of the light distribution data generation, for example, when the median value of music data in a predetermined first period T1 (for example, 8.3 ms) is larger than the average value of music data in a second period T2 (for example, 1 s) longer than the first period T1, the maximum value of the music data in the first period T1 is set as a representative value, and light distribution data corresponding to the first period T1 is generated based on the representative value. When the median value of the music data in the first period T1 is equal to or smaller than the average value of the music data in the second period T2, the minimum value of the music data in the first period T1 is set as a representative value, and light distribution data corresponding to the first period T1 is generated based on the representative value.

As a second example of the light distribution data generation, for example, existing audio editing software or the like is used to detect, as the first period T1, an inter-beat interval detected based on the periodicity (for example, beats, rhythm, or tempo) of music data, and the music data length is set as the second period T2. When the median value of the music data in the first period T1 is larger than the average value of the music data in the second period T2, the maximum value of the music data in the first period T1 is set as a representative value, and light distribution data corresponding to the first period T1 is generated based on the representative value. When the median value of the music data in the first period T1 is equal to or smaller than the average value of the music data in the second period T2, the minimum value of the music data in the first period T1 is set as a representative value, and light distribution data corresponding to the first period T1 is generated based on the representative value.

As a third example of the light distribution data generation, for example, existing audio editing software or the like is used to detect, as the first period T1, an inter-beat interval detected based on the periodicity of music data. The music data length is set as the second period T2. The minimum value of the music data in the first period T1 is set as a representative value, and light distribution data corresponding to the first half of the first period T1 is generated based on the representative value. The maximum value of the music data in the first period T1 is set as a representative value, and light distribution data corresponding to the second half of the first period T1 is generated based on the representative value.

As a fourth example of the light distribution data generation, for example, existing audio editing software or the like is used to detect, as the first period T1, an inter-beat interval detected based on the periodicity of music data. The music data length is set as the second period T2. The first value of the music data in the first period T1 is set as a representative value, and light distribution data corresponding to the first half of the first period T1 is generated based on the representative value. When the first value of the music data in the first period T1 is equal to or smaller than the average value of the music data in the second period T2, the maximum value of the music data in the first period T1 is set as a representative value, and light distribution data corresponding to the second half of the first period T1 is generated based on the representative value. When the first value of the music data in the first period T1 is larger than the average value of the music data in the second period T2, the minimum value of the music data in the first period T1 is set as a representative value, and light distribution data corresponding to the second half of the first period T1 is generated based on the representative value.

The range of change in light distribution data corresponding to music data is set, for example, linearly with respect to the music data.

Alternatively, when the range of change in music data is small or when the installation area of the illumination device 1 is large and the irradiation area of light from the illumination device 1 is relatively narrow, the range of change in light distribution data may be set to be large (for example, twice) with respect to the range of change in music data.

When the installation area of the illumination device 1 is narrow, the range of change in light distribution data may be set to be small (for example, ½) with respect to the range of change in music data.

Light distribution data may be the same in both of the two directions of the Dx and Dy directions, or may be different between the Dx direction and the Dy direction. Specifically, for example, the range of change in light distribution data in the Dx direction may be set linearly with respect to the full-scale value of music data, and the range of change in light distribution data in the Dy direction may be set to be large (or small) with respect to the range of change in music data. Alternatively, for example, the range of change in light distribution data in the Dx direction may be set to be large (or small) with respect to the range of change in music data, and the range of change in light distribution data in the Dy direction may be set linearly with respect to the full-scale value of music data.

When music data is a stereo sound source, light distribution data in the Dx direction may be generated based on right audio data (or left audio data), and light distribution data in the Dy direction may be generated based on left audio data (or right audio data).

Hereinafter, to simplify the description, an example will be described in which music data for generating light distribution data is a mono sound source and the same light distribution data is generated for both the two directions of the Dx and Dy directions from the mono sound source.

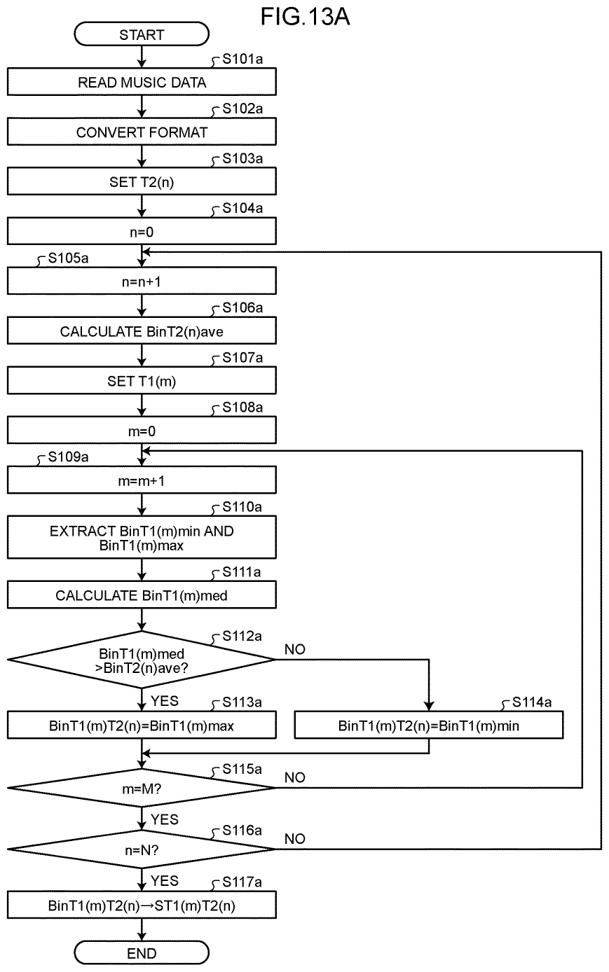

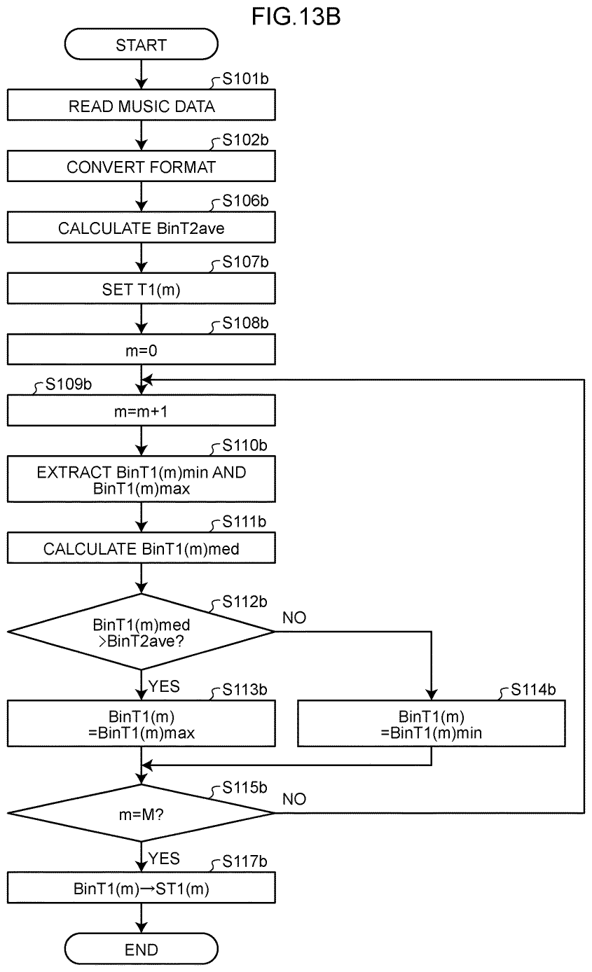

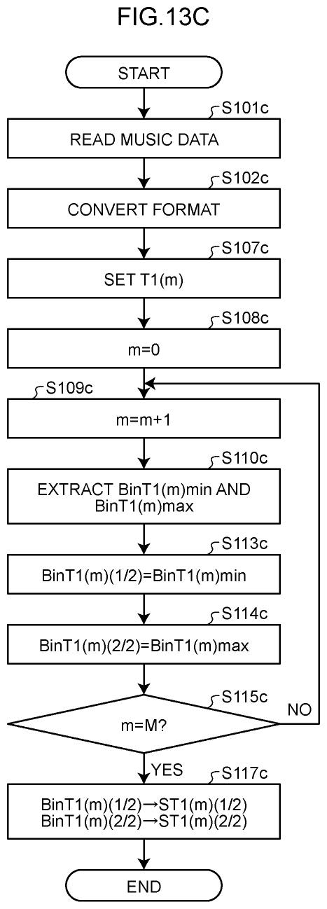

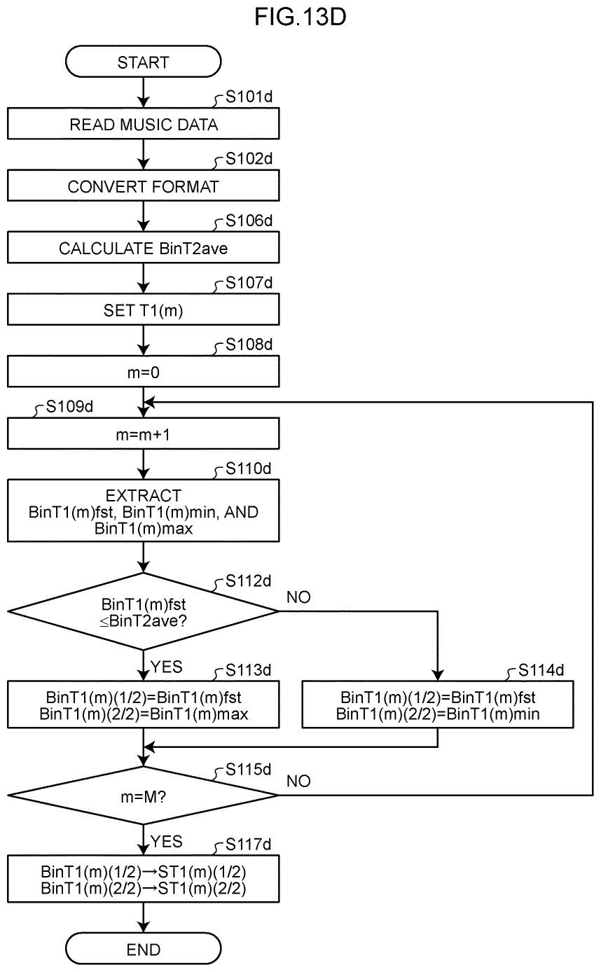

FIG. 13A is a flowchart illustrating a first example of the light distribution data generation process according to the embodiment. In the present disclosure, the light distribution data generation process is executed by audio editing software operating on the control device 300.

The processing circuit 310 reads music data from the storage circuit 323 (step S101a) and performs format conversion of the read music data (step S102a). Specifically, in this example, the music data is converted into mono uncompressed PCM data of 8 bits/6 kHz sampling. The present disclosure is not limited by the format conversion.

The processing circuit 310 sets a second period T2(n) (for example, 1 s) for the music data after the format conversion (step S103a).

The total number of second periods T2(n) included in the music data after the format conversion is defined as N. When the music data length is defined as T, the last second period T2(N) of the music data can be represented by Expression (1) below.

T2(N)=T−{T2(1)+T2(2)+ . . . +T2(N−1)} (1)

The processing circuit 310 sets n=0 (step S104a), sets n=n+1 (step S105a), and calculates an average value BinT2(n)ave of a plurality of pieces of binary data (in this example, 6000 pieces of binary data) included in the second period T2(n) (step S106a). Hereinafter, a plurality of pieces of binary data is simply referred to as “a plurality of binary data pieces” or “binary data pieces” in some cases.

Subsequently, the processing circuit 310 sets the first period T1(m) (for example, 8.3 ms) for the music data after the format conversion (step S107a).

The total number of first periods T1(m) included in the second period T2(n) for the music data after the format conversion is defined as M. In the last second period T2(N) of the music data, the last first period T1(M) of the second period T2(N) can be represented by Expression (2) below.

T1(M)=T2(N)−{T1(1)+T1(2)+ . . . +T1(M−1)} (2)

Subsequently, the processing circuit 310 sets m=0 (step S108a), sets m=m+1 (step S109a). The processing circuit 310 extracts a minimum value BinT1(m)min and a maximum value BinT1(m)max of a plurality of binary data pieces (in this example, 100 binary data pieces) included in the first period T1(m) (step S110a). The processing circuit 310 also calculates a median value BinT1(m)med of the binary data pieces (in this example, 100 binary data pieces) included in the first period T1(m) (step S111a), and determines whether the median value BinT1(m)med of the binary data pieces in the first period T1(m) is larger than the average value BinT2(n)ave of the binary data pieces in the second period T2(n) (BinT1(m)med>BinT2(n)ave; step S112a).

In the case of BinT1(m)med>BinT2(n)ave (Yes at step S112a), the processing circuit 310 sets the maximum value BinT1(m)max of the binary data pieces in the first period T1(m) of the second period T2(n) (hereinafter also referred to as a “T1(m)T2(n) period”) as a binary data piece BinT1(m)T2(n) in the T1(m)T2(n) period (step S113a). In the case of BinT1(m)med ≤BinT2(n)ave (No at step S112a), the processing circuit 310 sets the minimum value BinT1(m)min of the binary data pieces in the T1(m)T2(n) period as the binary data piece BinT1(m)T2(n) in the T1(m)T2(n) period (step S114a).

The processing circuit 310 determines whether m is equal to M (step S115a). When m is not equal to M (No at step S115a), the processing circuit 310 returns to step S109a and repeatedly executes the process from step S109a to step S115a.

When m is equal to M (Yes at step S115a), the processing circuit 310 subsequently determines whether n is equal to N (step S116a). When n is not equal to N (No at step S116a), the processing circuit 310 returns to step S105a and repeatedly executes the process from step S105a to step S116a.

When n is equal to N (Yes at step S116a), the processing circuit 310 converts the binary data piece BinT1(m)T2(n) in the T1(m)T2(n) period into light distribution data ST1(m)T2(n) and stores the light distribution data ST 1(m)T2(n) in the storage circuit 323 (step S117a), and ends the light distribution data generation process illustrated in FIG. 13A. In the first example illustrated in FIG. 13A, the light distribution data ST1(m)T2(n) is associated with the period T1(m)T2(n) in the music data and stored in the storage circuit 323. In the present disclosure, a conversion table of light distribution data corresponding to binary data pieces of the music data after the format conversion is stored in the storage circuit 323 in advance.

FIG. 13B is a flowchart illustrating a second example of the light distribution data generation process according to the embodiment. The following describes steps different from those of the first example illustrated in FIG. 13A in detail, but omits the description of the steps similar to those of the first example illustrated in FIG. 13A in some cases.

The processing circuit 310 reads music data from the storage circuit 323 (step S101b) and performs format conversion of the read music data (step S102b).

The processing circuit 310 sets the music data length as the second period T2 and calculates an average value BinT2ave of all binary data pieces included in the second period T2 (step S106b).

Subsequently, the processing circuit 310 detects, for the music data after the format conversion, the periodicity (for example, beats, rhythm, or tempo) of the music data by using existing audio editing software or the like. The periodicity of music is not necessarily detected at a constant period. Thus, the period of an inter-beat interval detected by the audio editing software or the like is set as the first period T1(m) (step S107b). When a period including part of music data not detected as the inter-beat interval exists before the first period T1(1) of the inter-beat interval detected by the existing audio editing software or the like, the period may be set as the first period T1(1) to execute subsequent process.

The total number of first periods T1(m) included in the music data after the format conversion is defined as M. When the music data length is defined as T2, the last first period T1(M) of the music data can be represented by Expression (3) below.

T1(M)=T2−{T1(1)+T1(2)+ . . .+T2(M−1)} (3)

Subsequently, the processing circuit 310 sets m=0 (step S108b), sets m=m+1 (step S109b), extracts the minimum value BinT1(m)min and the maximum value BinT1(m)max of a plurality of binary data pieces included in the first period T1(m) (step S110b). The processing circuit 310 also calculates the median value BinT1(m)med of the binary data pieces included in the first period T1(m) (step S111b), and determines whether the median value BinT1(m)med of the binary data pieces in the first period T1(m) is larger than the average value BinT2ave of the binary data pieces in the second period T2 (BinT1(m)med>BinT2ave; step S112b).

In the case of BinT1(m)med>BinT2ave (Yes at step S112b), the processing circuit 310 sets the maximum value BinT1(m)max of the binary data pieces in the first period T1(m) as a binary data piece BinT1(m) in the first period T1(m) (step S113b). In the case of BinT1(m)med≤BinT2ave (No at step S112b), the processing circuit 310 sets the minimum value BinT1(m)min of the binary data pieces in the first period T1(m) as the binary data piece BinT1(m) in the first period T1(m) (step S114b).

The processing circuit 310 determines whether m is equal to M (step S115b). When m is not equal to M (No at step S115b), the processing circuit 310 returns to step S109b and repeatedly executes the process from step S109b to step S115b.

When m is equal to M (Yes at step S115b), the processing circuit 310 converts the binary data piece BinT1(m) in the first period T1(m) into light distribution data ST1(m) and stores the light distribution data ST1(m) in the storage circuit 323 (step S117b), and ends the light distribution data generation process illustrated in FIG. 13B. In the second example illustrated in FIG. 13B, the light distribution data ST1(m) is associated with the period T1(m) in the music data and stored in the storage circuit 323.

FIG. 13C is a flowchart illustrating a third example of the light distribution data generation process according to the embodiment. The following describes steps different from those of the second example illustrated in FIG. 13B in detail, but omits the description of the steps similar to those of the second example illustrated in FIG. 13B in some cases.

The processing circuit 310 reads music data from the storage circuit 323 (step S101 c) and performs format conversion of the read music data (step S102c).

The processing circuit 310 sets, for the music data after the format conversion, the period of an inter-beat interval detected by audio editing software or the like as the first period T1(m) (step S107c). When a period including part of music data not detected as the inter-beat interval exists before the first period T1(1) of the inter-beat interval detected by the existing audio editing software or the like, the period may be set as the first period T1(1) to execute subsequent process.

The total number of first periods T1(m) included in the music data after the format conversion is defined as M. When the music data length is defined as T2, the last first period T1(M) of the music data can be represented by Expression (3) above.

Subsequently, the processing circuit 310 sets m=0 (step S108c), sets m=m+1 (step S109c), and extracts the minimum value BinT1(m)min and the maximum value BinT1(m)max of a plurality of binary data pieces included in the first period T1(m) (step S110c). The processing circuit 310 sets the minimum value BinT1(m)min of the binary data pieces in the first period T1(m) as a binary data piece BinT1(m)(½) in a period T1(m)(½) of the first half of the first period T1(m) (step S113c). The processing circuit 310 sets the maximum value BinT1(m)max of the binary data pieces in the first period T1(m) as a binary data piece BinT1(m)( 2/2) in a period T1(m)( 2/2) of the second half of the first period T1(m) (step S114c).

The processing circuit 310 determines whether m is equal to M (step S115c). When m is not equal to M (No at step S115c), the processing circuit 310 returns to step S109c and repeatedly executes the process from step S109c to step S115c.

When m is equal to M (Yes at step S115c), the processing circuit 310 converts the binary data piece BinT1(m)(½) in the period T1(m)(½) of the first half of the first period T1(m) into light distribution data ST1(m) (½), converts the binary data piece BinT1(m)( 2/2) in the period T1(m)( 2/2) of the second half of the first period T1(m) into light distribution data ST1(m)( 2/2), stores the light distribution data ST1(m)(½) and ST1(m)( 2/2) in the storage circuit 323 (step S117c), and ends the light distribution data generation process illustrated in FIG. 13C. In the third example illustrated in FIG. 13C, the light distribution data ST1(m)(½) and ST1(m)( 2/2) is associated with the periods T1(m)(½) and T1(m)( 2/2) in the music data and stored in the storage circuit 323.

FIG. 13D is a flowchart illustrating a fourth example of the light distribution data generation process according to the embodiment. The following describes steps different from those of the second example illustrated in FIG. 13B or the third example illustrated in FIG. 13C in detail, but omits the description of the steps similar to those of the second example illustrated in FIG. 13B or the third example illustrated in FIG. 13C in some cases.

The processing circuit 310 reads music data from the storage circuit 323 (step S101d) and performs format conversion of the read music data (step S102d).

The processing circuit 310 sets the music data length as the second period T2 and calculates the average value BinT2ave of all binary data pieces included in the second period T2 (step S106d).

Subsequently, the processing circuit 310 sets, for the music data after the format conversion, the period of the inter-beat interval detected by the existing audio editing software or the like as the first period T1(m) (step S107d). When a period including part of music data not detected as the inter-beat interval exists before the first period T1(1) of the inter-beat interval detected by the existing audio editing software or the like, the period may be set as the first period T1(1) to execute subsequent process.

The total number of first periods T1(m) included in the music data after the format conversion is defined as M. When the music data length is defined as T2, the last first period T1(M) of the music data can be represented by Expression (3) above.

Subsequently, the processing circuit 310 sets m=0 (step S108d), sets m=m+1 (step S109d), extracts a first value BinT1(m)fst, the minimum value BinT1(m)min, and the maximum value BinT1(m)max of a plurality of binary data pieces included in the first period T1(m) (step S110d), and determines whether the first value BinT1(m)fst of the binary data pieces in the first period T1(m) is equal to or smaller than the average value BinT2ave of the binary data pieces in the second period T2 (BinT1(m)fst≤BinT2ave; step S112d).

In the case of BinT1(m)fst≤BinT2ave (Yes at step S112d), the processing circuit 310 sets the first value BinT1(m)fst of the binary data pieces in the first period T1(m) as the binary data piece BinT1(m)(½) in the period T1(m)(½) of the first half of the first period T1(m), and sets the maximum value BinT1(m)max of the binary data pieces in the first period T1(m) as the binary data piece BinT1(m)( 2/2) in the period T1(m)( 2/2) of the second half of the first period T1(m) (step S113d). In the case of BinT1(m)fst>BinT2ave (No at step S112d), the processing circuit 310 sets the first value BinT1(m)fst of the binary data pieces in the first period T1(m) as the binary data piece BinT1(m)(½) in the period T1(m)(½) of the first half of the first period T1(m), and sets the minimum value BinT1(m)min of the binary data pieces in the first period T1(m) as the binary data piece BinT1(m)( 2/2) in the period T1(m)( 2/2) of the second half of the first period T1(m) (step S114d).

The processing circuit 310 determines whether m is equal to M (step S115d). When m is not equal to M (No at step S115d), the processing circuit 310 returns to step S109d and repeatedly executes the process from step S109d to step S115d.

When m is equal to M (Yes at step S115d), the processing circuit 310 converts the binary data piece BinT1(m)(½) in the period T1(m)(½) of the first half of the first period T1(m) into the light distribution data ST1(m)(½), converts the binary data piece BinT1(m)( 2/2) in the period T1(m)( 2/2) of the second half of the first period T1(m) into the light distribution data ST1(m)( 2/2) and stores the light distribution data ST1(m)(½) and ST1(m)( 2/2) in the storage circuit 323 (step S117d), and ends the light distribution data generation process illustrated in FIG. 13D. In the fourth example illustrated in FIG. 13D, the light distribution data ST1(m)(½) and ST1(m)( 2/2) is associated with the periods T1(m)(½) and T1(m)( 2/2) in the music data and stored in the storage circuit 323, in the same manner as the third example illustrated in FIG. 13C.

The following describes configurations of the illumination device 1 and the speaker device 400 necessary for performing the music-following light distribution control in the illumination system 200 according to the first embodiment.

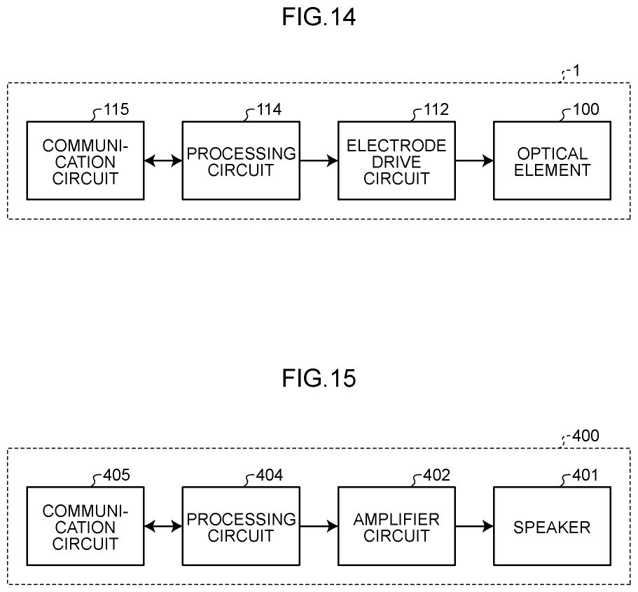

FIG. 14 is a block diagram illustrating an example of the illumination device 1 according to the first embodiment. As illustrated in FIG. 14, the illumination device 1 according to the first embodiment includes the optical element 100, an electrode drive circuit 112, a processing circuit 114, and a communication circuit 115. The processing circuit 114 is configured with, for example, a microcomputer. In addition to the above, the configuration may include, for example, a storage circuit configured with a RAM, an EEPROM, a ROM, or the like, and various interface circuits such as a power button and a mode selection switch.

The communication circuit 115 receives light distribution data transmitted from the control device 300. The processing circuit 114 converts the light distribution data received by the communication circuit 115 into a predetermined gradation value. The electrode drive circuit 112 supplies drive voltage corresponding to the gradation value converted by the processing circuit 114 to the drive electrodes 10 and 13 of each liquid crystal cell 2 of the optical element 100.

FIG. 15 is a block diagram illustrating an example of the speaker device 400 according to the first embodiment. As illustrated in FIG. 15, the speaker device 400 according to the first embodiment includes a speaker 401, an amplifier circuit 402, a processing circuit 404, and a communication circuit 405. The processing circuit 404 is configured with, for example, a microcomputer. In addition to the above, the configuration may include, for example, a storage circuit configured with a RAM, an EEPROM, a ROM, or the like, and various interface circuits such as a power button and a mode selection switch.

The communication circuit 405 receives music data transmitted from the control device 300. The processing circuit 404 converts the music data received by the communication circuit 405 into a signal corresponding to the input format of the amplifier circuit 402. The amplifier circuit 402 amplifies the signal converted by the processing circuit 404 and supplies the amplified signal to the speaker 401.

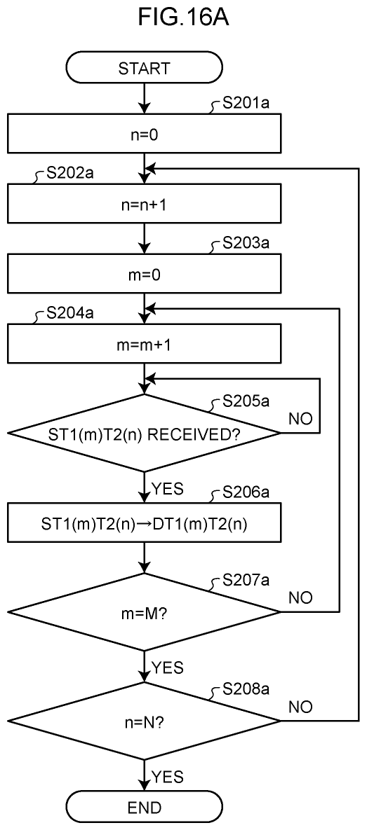

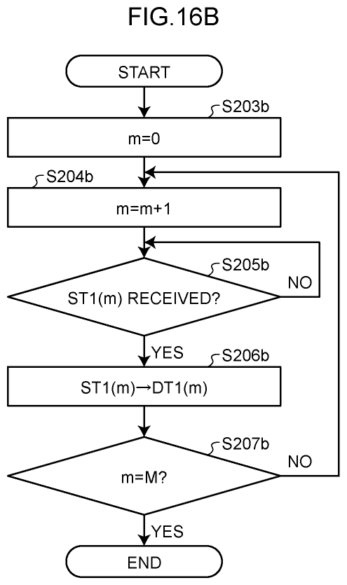

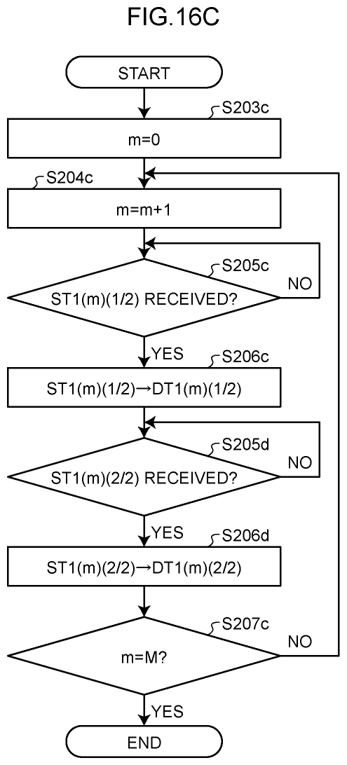

The following describes specific examples of the music-following light distribution control process according to the first embodiment with reference to FIGS. 16A, 16B, and 16C.

FIG. 16A is a flowchart illustrating a first example of the music-following light distribution control process according to the first embodiment. The following describes a specific example of a process using the light distribution data ST1(m)T2(n) generated in the light distribution data generation process illustrated in FIG. 13A.

In the illumination system 200 according to the first embodiment, when the music-following light distribution control is started, the control device 300 transmits light distribution data to the illumination device 1 in synchronization with music data transmitted to the speaker device 400. Specifically, in the first example illustrated in FIG. 16A, the control device 300 transmits the light distribution data ST1(m)T2(n) corresponding to the period T1(m)T2(n) to the illumination device 1 in the period T1(m)T2(n) in the music data.

In the first embodiment, the music-following light distribution control process is started by, for example, control software operating on the control device 300. Specifically, the music-following light distribution control process may be started by selecting an object provided on a display screen of the control software, or the music-following light distribution control process may be started by a timer or the like.

When the music-following light distribution control is started, the processing circuit 114 of the illumination device 1 sets n=0 (step S201a), n=n+1 (step S202a), m=0 (step S203a), and m=m+1 (step S204a), and determines whether the light distribution data ST1(m)T2(n) is received (step S205a). When the light distribution data ST1(m)T2(n) is not received (No at step S205a), processing at step S205a is repeatedly executed. When the light distribution data ST1(m)T2(n) is received (Yes at step S205a), the processing circuit 114 converts the received light distribution data ST1(m)T2(n) into a gradation value DT1(m)T2(n) (step S206a).

The electrode drive circuit 112 supplies drive voltage corresponding to the gradation value DT1(m)T2(n) to the drive electrodes 10 and 13 of each liquid crystal cell 2 of the optical element 100. Accordingly, the optical element 100 is controlled to be brought into a light distribution state in accordance with the light distribution data ST1(m)T2(n).

The processing circuit 114 determines whether m is equal to M (step S207a). When m is not equal to M (No at step S207a), the processing circuit 114 returns to step S204a and repeatedly executes the process from step S204a to step S207a.

When m is equal to M (Yes at step S207a), the processing circuit 114 subsequently determines whether n is equal to N (step S208a). When n is not equal to N (No at step S208a), the processing circuit 114 returns to step S202a and repeatedly executes the process from step S202a to step S208a. When n is equal to N (Yes at step S208a), the music-following light distribution control process illustrated in FIG. 16A is ended.

FIG. 16B is a flowchart illustrating a second example of the music-following light distribution control process according to the first embodiment. The following describes a specific example of a process using the light distribution data ST1(m) generated in the light distribution data generation process illustrated in FIG. 13B.

In the second example illustrated in FIG. 16B, the control device 300 transmits the light distribution data ST1(m) corresponding to the period T1(m) in music data to the illumination device 1 in the period T1(m).

When the music-following light distribution control is started, the processing circuit 114 of the illumination device 1 sets m=0 (step S203b) and m=m+1 (step S204b) and determines whether the light distribution data ST1(m) is received (step S205b). When the light distribution data ST1(m) is not received (No at step S205b), processing at step S205b is repeatedly executed. When the light distribution data ST1(m) is received (Yes at step S205b), the processing circuit 114 converts the received light distribution data ST1(m) into a gradation value DT1(m) (step S206b).

The electrode drive circuit 112 supplies drive voltage corresponding to the gradation value DT1(m) to the drive electrodes 10 and 13 of each liquid crystal cell 2 of the optical element 100. Accordingly, the optical element 100 is controlled to be brought into a light distribution state in accordance with the light distribution data ST1(m).

The processing circuit 114 determines whether m is equal to M (step S207b). When m is not equal to M (No at step S207b), the processing circuit 114 returns to step S204b and repeatedly executes the process from step S204b to step S207b. When m is equal to M (Yes at step S207b), the music-following light distribution control process illustrated in FIG. 16B is ended.

FIG. 16C is a flowchart illustrating a third example of the music-following light distribution control process according to the first embodiment. The following describes a specific example of a process using the light distribution data ST1(m)(½) and ST1(m)( 2/2) generated in the light distribution data generation process illustrated in FIG. 13C or 13D.

In the third example illustrated in FIG. 16C, the control device 300 transmits the light distribution data ST1(m)(½) and ST1(m)( 2/2) corresponding to the periods T1(m)(½) and T1(m)( 2/2) in music data to the illumination device 1 in the periods T1(m)(½) and T1(m)( 2/2).

When the music-following light distribution control is started, the processing circuit 114 of the illumination device 1 sets m=0 (step S203c) and m=m+1 (step S204c) and determines whether the light distribution data ST1(m) (½) is received (step S205c). When the light distribution data ST1(m)(½) is not received (No at step S205c), processing at step S205c is repeatedly executed. When the light distribution data ST1(m)(½) is received (Yes at step S205c), the processing circuit 114 converts the received light distribution data ST1(m)(½) into the gradation value DT1(m)(½) (step S206c).

The electrode drive circuit 112 supplies drive voltage corresponding to the gradation value DT1(m)(½) to the drive electrodes 10 and 13 of each liquid crystal cell 2 of the optical element 100. Accordingly, the optical element 100 is controlled to be brought into a light distribution state in accordance with the light distribution data ST1(m) (½).

Subsequently, the processing circuit 114 determines whether the light distribution data ST1(m)( 2/2) is received (step S205d). When the light distribution data ST1(m)( 2/2) is not received (No at step S205d), processing at step S205d is repeatedly executed. When the light distribution data ST1(m)( 2/2) is received (Yes at step S205d), the processing circuit 114 converts the received light distribution data ST1(m)( 2/2) into the gradation value DT1(m)( 2/2) (step S206d).

The electrode drive circuit 112 supplies drive voltage corresponding to the gradation value DT1(m)( 2/2) to the drive electrodes 10 and 13 of each liquid crystal cell 2 of the optical element 100. Accordingly, the optical element 100 is controlled to be brought into a light distribution state in accordance with the light distribution data ST1(m) ( 2/2).

The processing circuit 114 determines whether m is equal to M (step S207c). When m is not equal to M (No at step S207c), the processing circuit 114 returns to step S204c and repeatedly executes the process from step S204c to step S207c. When m is equal to M (Yes at step S207c), the music-following light distribution control process illustrated in FIG. 16C is ended.

### Second Embodiment

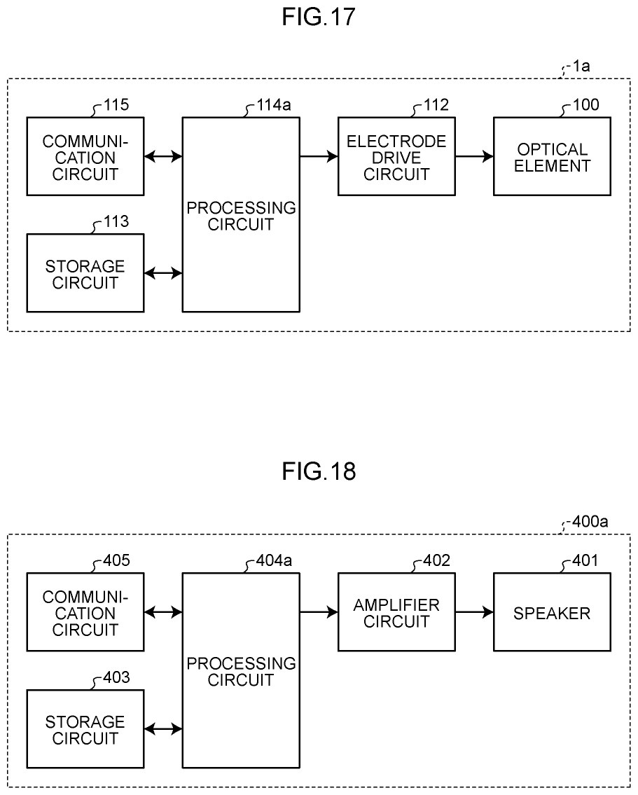

FIG. 17 is a block diagram illustrating an example of an illumination device 1a according to a second embodiment. FIG. 18 is a block diagram illustrating an example of a speaker device 400a according to the second embodiment.

The illumination device 1a according to the second embodiment includes a storage circuit 113 in addition to the configuration of the illumination device 1 according to the first embodiment. The storage circuit 113 is configured with, for example, a RAM, an EEPROM, or a ROM. The illumination device 1a according to the second embodiment may also include a power button, a mode selection switch, or an interface circuit for starting or stopping the music-following light distribution control process.

The speaker device 400a according to the second embodiment includes a storage circuit 403 in addition to the configuration of the speaker device 400 according to the first embodiment. The storage circuit 403 is configured with, for example, a RAM, an EEPROM, or a ROM. The speaker device 400a according to the second embodiment may also include a power button, a mode selection switch, or an interface circuit for starting or stopping the music-following light distribution control process.

In the second embodiment, music data is transmitted from the control device 300 to the speaker device 400a and stored in the storage circuit 403 of the speaker device 400a in advance. A processing circuit 404a reads the music data stored in the storage circuit 403 and converts the music data into a signal corresponding to the input format of the amplifier circuit 402.

Light distribution data is transmitted from the control device 300 to the illumination device 1a and stored in the storage circuit 113 of the illumination device 1a in advance. A processing circuit 114a reads light distribution data stored in the storage circuit 113 and converts the light distribution data into a predetermined gradation value.

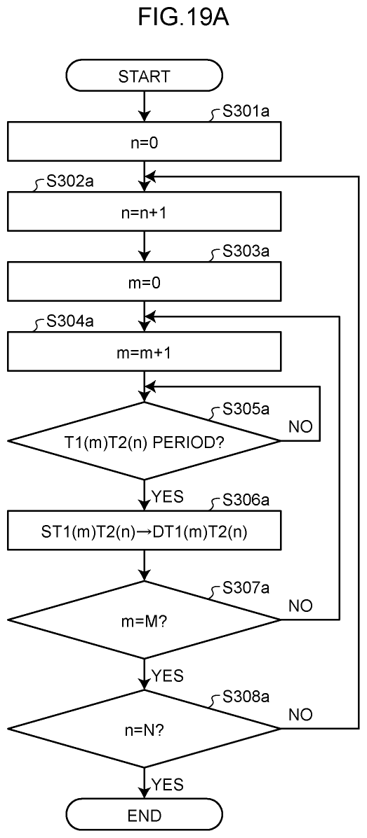

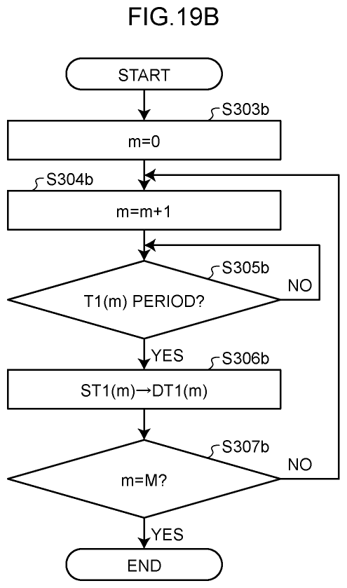

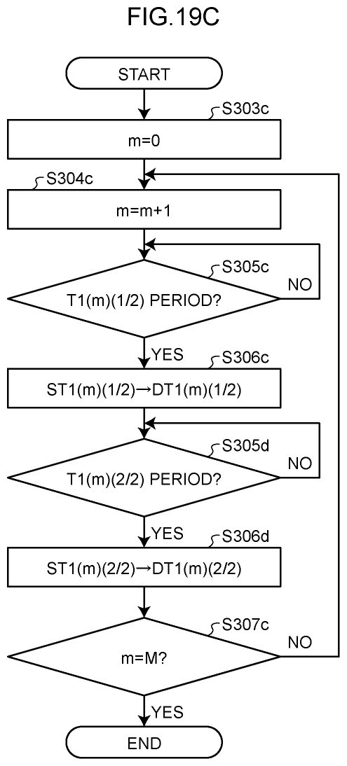

The following describes specific examples of the music-following light distribution control process according to the second embodiment with reference to FIGS. 19A, 19B, and 19C.

FIG. 19A is a flowchart illustrating a first example of the music-following light distribution control process according to the second embodiment. The following describes a specific example of a process using the light distribution data ST1(m)T2(n) generated in the light distribution data generation process illustrated in FIG. 13A.

In the illumination system 200 according to the second embodiment, when the music-following light distribution control is started, the illumination device 1a reads light distribution data stored in the storage circuit 113, in synchronization with music data played by the speaker device 400a. Specifically, in the first example illustrated in FIG. 19A, the illumination device 1a reads the light distribution data ST1(m)T2(n) corresponding to the period T1(m)T2(n) in the music data from the storage circuit 113 in the period T1(m)T2(n).

In the second embodiment, the music-following light distribution control process is started by, for example, the interface circuit provided in the speaker device 400a or the illumination device 1a. The interface circuit may be, for example, a physical switch circuit or may be achieved by, for example, selecting an object provided on a touch panel. For example, the music-following light distribution control process may be started by selecting an object provided on a touch panel, or the music-following light distribution control process may be started by means of a timer or the like.

When the music-following light distribution control is started, the processing circuit 114a of the illumination device 1a activates a timer, sets n=0 (step S301a), n=n+1 (step S302a), m=0 (step S303a), m=m+1 (step S304a), and determines whether the time is within the T1(m)T2(n) period (step S305a). When the time is not within the T1(m)T2(n) period (No at step S305a), processing at step S305a is repeatedly executed. When the time is within the T1(m)T2(n) period (Yes at step S305a), the processing circuit 114a reads the light distribution data ST1(m)T2(n) corresponding to the T1(m)T2(n) period from the storage circuit 113 and converts the light distribution data ST1(m)T2(n) into the gradation value DT1(m)T2(n) (step S306a).

The electrode drive circuit 112 supplies drive voltage corresponding to the gradation value DT1(m)T2(n) to the drive electrodes 10 and 13 of each liquid crystal cell 2 of the optical element 100. Accordingly, the optical element 100 is controlled to be brought into a light distribution state in accordance with the light distribution data ST1(m)T2(n).

The processing circuit 114a determines whether m is equal to M (step S307a). When m is not equal to M (No at step S307a), the processing circuit 114a returns to step S304a and repeatedly executes the process from step S304a to step S307a.

When m is equal to M (Yes at step S307a), the processing circuit 114a subsequently determines whether n is equal to N (step S308a). When n is not equal to N (No at step S308a), the processing circuit 114a returns to step S302a and repeatedly executes the process from step S302a to step S308a. When n is equal to N (Yes at step S308a), the music-following light distribution control process illustrated in FIG. 19A is ended.

FIG. 19B is a flowchart illustrating a second example of the music-following light distribution control process according to the second embodiment. The following describes a specific example of a process using the light distribution data ST1(m) generated in the light distribution data generation process illustrated in FIG. 13B.

In the second example illustrated in FIG. 19B, the illumination device 1a reads the light distribution data ST1(m) corresponding to the period T1(m) in the music data from the storage circuit 113 in the period T1(m).

When the music-following light distribution control is started, the processing circuit 114a of the illumination device 1a activates a timer, sets m=0 (step S303b) and m=m+1 (step S304b), and determines whether the time is within the T1(m) period (step S305b). When the time is not within the T1(m) period (No at step S305b), processing at step S305b is repeatedly executed. When the time is within the T1(m) period (Yes at step S305b), the processing circuit 114a reads the light distribution data ST1(m) corresponding to the T1(m) period from the storage circuit 113 and converts the light distribution data ST1(m) into the gradation value DT1(m) (step S306b).

The electrode drive circuit 112 supplies drive voltage corresponding to the gradation value DT1(m) to the drive electrodes 10 and 13 of each liquid crystal cell 2 of the optical element 100. Accordingly, the optical element 100 is controlled to be brought into a light distribution state in accordance with the light distribution data ST1(m).

The processing circuit 114a determines whether m is equal to M (step S307b). When m is not equal to M (No at step S307b), the processing circuit 114a returns to step S304b and repeatedly executes the process from step S304b to step S307b. When m is equal to M (Yes at step S307b), the music-following light distribution control process illustrated in FIG. 19B is ended.

FIG. 19C is a flowchart illustrating a third example of the music-following light distribution control process according to the second embodiment. The following describes a specific example of a process using the light distribution data ST1(m)(½) and ST1(m)( 2/2) generated in the light distribution data generation process illustrated in FIGS. 13C and 13D.

In the third example illustrated in FIG. 19C, the illumination device 1a reads the light distribution data ST1(m)(½) and ST1(m)( 2/2) corresponding to the periods T1(m)(½) and T1(m)( 2/2) in music data from the storage circuit 113 in the periods T1(m)(½) and T1(m)( 2/2).

When the music-following light distribution control is started, the processing circuit 114a of the illumination device 1a activates a timer, sets m=0 (step S303c) and m=m+1 (step S304c), and determines whether the time is within the T1(m)(½) period (step S305c). When the time is not within the T1(m)(½) period (No at step S305c), processing at step S305c is repeatedly executed. When the time is within the T1(m)(½) period (Yes at step S305c), the processing circuit 114a reads the light distribution data ST1(m)(½) corresponding to the T1(m)(½) period from the storage circuit 113 and converts the light distribution data ST1(m)(½) into the gradation value DT1(m)(½) (step S306c).

The electrode drive circuit 112 supplies drive voltage corresponding to the gradation value DT1(m)(½) to the drive electrodes 10 and 13 of each liquid crystal cell 2 of the optical element 100. Accordingly, the optical element 100 is controlled to be brought into a light distribution state in accordance with the light distribution data ST1(m) (½).

Subsequently, the processing circuit 114a determines whether the time is within the T1(m)( 2/2) period (step S305d). When the time is not within the T1(m)( 2/2) period (No at step S305d), processing at step S305d is repeatedly executed. When the time is within the T1(m)( 2/2) period (Yes at step S305d), the processing circuit 114a reads the light distribution data ST1(m)( 2/2) corresponding to the T1(m)( 2/2) period from the storage circuit 113 and converts the light distribution data ST1(m)( 2/2) into the gradation value DT1(m)( 2/2) (step S306d).

The electrode drive circuit 112 supplies drive voltage corresponding to the gradation value DT1(m)( 2/2) to the drive electrodes 10 and 13 of each liquid crystal cell 2 of the optical element 100. Accordingly, the optical element 100 is controlled to be brought into a light distribution state in accordance with the light distribution data ST1(m) ( 2/2).

The processing circuit 114a determines whether m is equal to M (step S307c). When m is not equal to M (No at step S307c), the processing circuit 114a returns to step S304c and repeatedly executes the process from step S304c to step S307c. When m is equal to M (Yes at step S307c), the music-following light distribution control process illustrated in FIG. 19C is ended.

### Modification

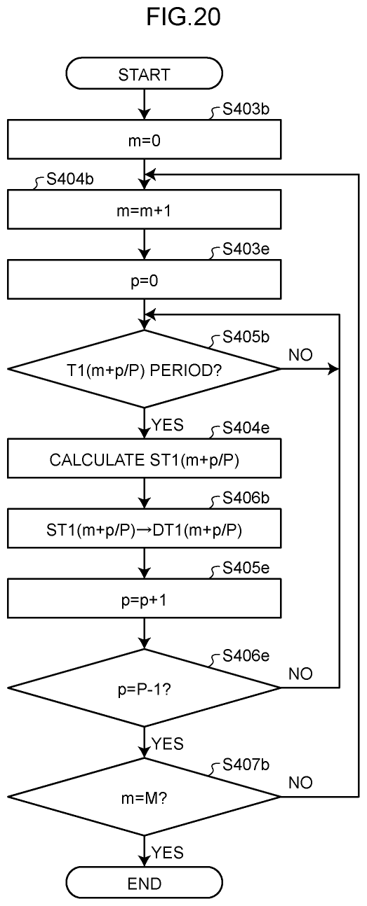

FIG. 20 is a flowchart illustrating the music-following light distribution control process according to a modification of the second embodiment. The following describes a specific example of a process in which the first period T1 is divided into P segments (P is an integer of two or more) and interpolation between the light distribution data ST1(m) and light distribution data ST1(m+1) generated in the light distribution data generation process illustrated in FIG. 13B is performed with an intermediate value. Alternatively, the T1(m)(½) period and the T1(m)( 2/2) period may be each divided into P segments (P is an integer of two or more), and interpolation between the light distribution data ST1(m) (½) and the light distribution data ST1(m)( 2/2) generated in the light distribution data generation process illustrated in FIG. 13C or 13D and interpolation between the light distribution data ST1(m)( 2/2) and the light distribution data ST1(m+1)(½) may each be performed with an intermediate value. The description will be made in detail on any difference from the flowchart illustrated in FIG. 19B, and duplicate description is omitted.

When the music-following light distribution control is started, the processing circuit 114a of the illumination device 1a activates a timer, sets m=0 (step S403b), m=m+1 (step S404b), and p=0 (step S403e) and determines whether the time is within a T1(m+p/P) period (step S405b). When the time is not within the T1(m+p/P) period (No at step S405b), processing at step S405b is repeatedly executed.

When the time is within the T1(m+p/P) period (Yes at step S405b), the processing circuit 114a reads the light distribution data ST1(m) and the light distribution data ST1(m+1) corresponding to the T1(m+p/P) period from the storage circuit 113 and calculates light distribution data ST1(m+p/P) corresponding to the T1(m+p/P) period (step S404e) and converts the calculated light distribution data ST1(m+p/P) into a gradation value DT1(m+p/P) (step S406b). The intermediate light distribution data ST(m+p/P) is represented by Expression (4) below.

S(m+p/P)=S(m)+{(S(m+1)−S(m))/P}×p (4)

The electrode drive circuit 112 supplies drive voltage corresponding to the gradation value DT1(m+p/P) to the drive electrodes 10 and 13 of each liquid crystal cell 2 of the optical element 100. Accordingly, the optical element 100 is controlled to be brought into a light distribution state in accordance with the light distribution data ST1(m+p/P).

Subsequently, the processing circuit 114a sets p=p+1 (step S405e) and determines whether p is equal to P−1 (step S406e). When p is not equal to P−1 (No at step S406e), the processing circuit 114a returns to step S405b and repeatedly executes the process from step S405b to step S406e.

When p is equal to P−1 (Yes at step S406e), the processing circuit 114a subsequently determines whether m is equal to M (step S407b). When m is not equal to M (No at step S407b), the processing circuit 114a returns to step S404b and repeatedly executes the process from step S404b to step S407b. When m is equal to M (Yes at step S407b), the music-following light distribution control process illustrated in FIG. 20 is ended.

### Third Embodiment

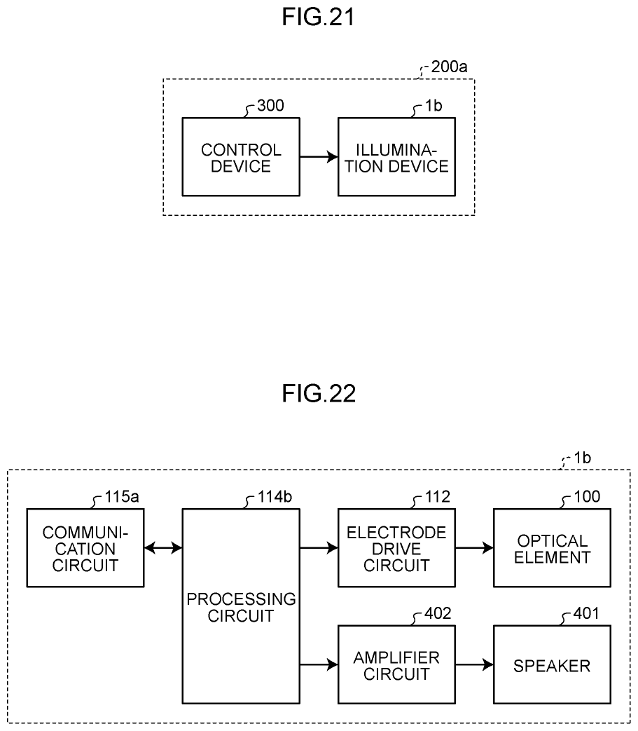

FIG. 21 is a diagram illustrating a schematic configuration of an illumination system 200a according to a third embodiment. As illustrated in FIG. 21, the illumination system 200a according to the third embodiment includes an illumination device 1b and the control device 300.

FIG. 22 is a block diagram illustrating an example of the illumination device 1b according to the third embodiment. The illumination device 1b according to the third embodiment includes the speaker 401 and the amplifier circuit 402 in addition to the configuration of the illumination device 1 according to the first embodiment. A communication circuit 115a receives music data and light distribution data transmitted from the control device 300. A processing circuit 114b converts the music data received by the communication circuit 115a into a signal corresponding to the input format of the amplifier circuit 402. The processing circuit 114b also converts the light distribution data received by the communication circuit 115a into a predetermined gradation value.

In the third embodiment, similarly to the illumination device 1 according to the first embodiment, the illumination device 1b executes the music-following light distribution control process in synchronization with the music data transmitted from the control device 300 to the speaker device 400. Specifically, the illumination device 1b executes the music-following light distribution control process illustrated in FIG. 16A by using, for example, the light distribution data ST1(m)T2(n) generated in the light distribution data generation process illustrated in FIG. 13A. The illumination device 1b also executes the music-following light distribution control process illustrated in FIG. 16B by using, for example, the light distribution data ST1(m) generated in the light distribution data generation process illustrated in FIG. 13B. The illumination device 1b also executes the music-following light distribution control process illustrated in FIG. 16C by using, for example, the light distribution data ST1(m)(½) and ST1(m) ( 2/2) generated in the light distribution data generation process illustrated in FIG. 13C or 13D.

### Fourth Embodiment

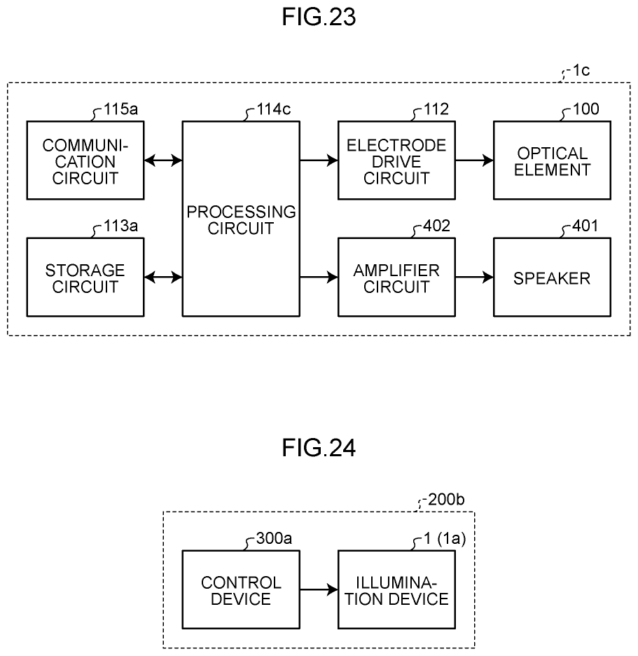

FIG. 23 is a block diagram illustrating an example of an illumination device 1c according to a fourth embodiment. The illumination device 1c according to the fourth embodiment includes a storage circuit 113a in addition to the configuration of the illumination device 1b according to the third embodiment. In the fourth embodiment, music data and light distribution data are transmitted from the control device 300 to the illumination device 1c and stored in the storage circuit 113a in advance.

In the fourth embodiment, the illumination device 1c synchronizes the music data and the light distribution data and executes the music-following light distribution control process. Specifically, the illumination device 1c executes the music-following light distribution control process illustrated in FIG. 19A by using, for example, the light distribution data ST1(m)T2(n) generated in the light distribution data generation process illustrated in FIG. 13A. The illumination device 1c also executes the music-following light distribution control process illustrated in FIG. 19B by using, for example, the light distribution data ST1(m) generated in the light distribution data generation process illustrated in FIG. 13B. The illumination device 1c also executes the music-following light distribution control process illustrated in FIG. 19C by using, for example, the light distribution data ST1(m)(½) and ST1(m) ( 2/2) generated in the light distribution data generation process illustrated in FIG. 13C or 13D.

In the fourth embodiment, similarly to the second embodiment, the first period T1 may be divided into P segments(P is an integer of two or more), and interpolation between the light distribution data ST1(m) and the light distribution data ST1(m+1) generated in the light distribution data generation process illustrated in FIG. 13B may be performed with an intermediate value. Alternatively, the T1(m)(½) period and the T1(m)( 2/2) period may be each divided into P segments (P is an integer of two or more), and interpolation between the light distribution data ST1(m)(½) and the light distribution data ST1(m)( 2/2) generated in the light distribution data generation process illustrated in FIG. 13C or 13D and interpolation between the light distribution data ST1(m) ( 2/2) and the light distribution data ST1(m+1)(½) may each be performed with an intermediate value.

### Fifth Embodiment

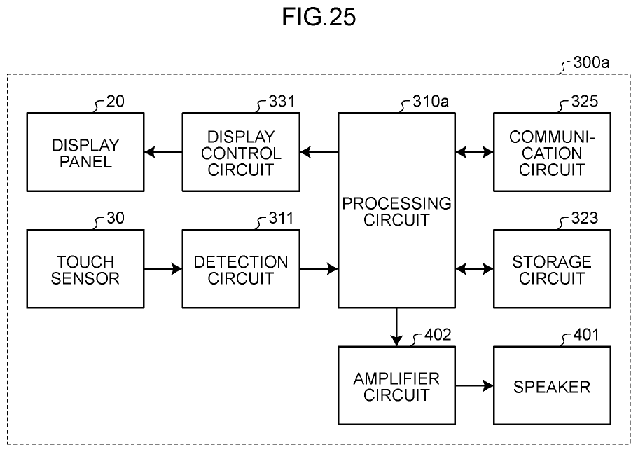

FIG. 24 is a diagram illustrating a schematic configuration of an illumination system 200b according to a fifth embodiment. As illustrated in FIG. 25, the illumination system 200b according to the fifth embodiment includes the illumination device 1 (1a) and a control device 300a.
FIG. 25 is a block diagram illustrating an example of the control device 300a according to the fifth embodiment. The control device 300a according to the fifth embodiment includes the speaker 401 and the amplifier circuit 402 in addition to the configuration of the control device 300 illustrated in FIG. 11.

In the fifth embodiment, music data is played by the control device 300a. The control device 300a according to the fifth embodiment may be combined with the illumination device 1 according to the first embodiment. With this combination, the music-following light distribution control process illustrated in FIG. 16A may be executed by using the light distribution data ST1(m)T2(n) generated in the light distribution data generation process illustrated in FIG. 13A. Alternatively, the music-following light distribution control process illustrated in FIG. 16B may be executed by using the light distribution data ST1(m) generated in the light distribution data generation process illustrated in FIG. 13B. Alternatively, the music-following light distribution control process illustrated in FIG. 16C may be executed by using the light distribution data ST1(m) (½) and ST1(m)( 2/2) generated in the light distribution data generation process illustrated in FIG. 13C or 13D.

Alternatively, the control device 300a according to the fifth embodiment may be combined with the illumination device 1a according to the second embodiment. With this combination, the music-following light distribution control process illustrated in FIG. 19A may be executed by using the light distribution data ST1(m)T2(n) generated in the light distribution data generation process illustrated in FIG. 13A. Alternatively, the music-following light distribution control process illustrated in FIG. 19B may be executed by using the light distribution data ST1(m) generated in the light distribution data generation process illustrated in FIG. 13B. Alternatively, the music-following light distribution control process illustrated in FIG. 19C may be executed by using the light distribution data ST1(m) (½) and ST1(m)( 2/2) generated in the light distribution data generation process illustrated in FIG. 13C or 13D.

Similarly to the second embodiment and the fourth embodiment described above, the first period T1 may be divided into P segments (P is an integer of two or more), and interpolation between the light distribution data ST1(m) and the light distribution data ST1(m+1) generated in the light distribution data generation process illustrated in FIG. 13B may be performed with an intermediate value. Alternatively, the T1(m)(½) period and the T1(m)( 2/2) period may be each divided into P segments (P is an integer of two or more), and interpolation between the light distribution data ST1(m) (½) and the light distribution data ST1(m)( 2/2) generated in the light distribution data generation process illustrated in FIG. 13C or 13D and interpolation between the light distribution data ST1(m)( 2/2) and the light distribution data ST1(m+1)(½) may each be performed with an intermediate value.

In the above-described embodiments, an example is described in which music data for generating light distribution data is a mono sound source and the same light distribution data is generated for both the two directions of the Dx and Dy directions from the mono sound source, but as described above, light distribution data in the two directions of the Dx and Dy directions may be generated from, for example, a stereo sound source, and light distribution states in the two directions of the Dx and Dy directions may be dynamically controlled independently of each other. Alternatively, the ranges of change in light distribution data in the Dx and Dy directions may be changed, or for example, the directions of change in light distribution data in the Dx and Dy directions may be inverted with each other.

The above-described embodiments describes an example in which the music-following light distribution control process is ended after all light distribution data corresponding to one piece of music data is applied (FIGS. 16A to 16C, 19A to 19C, and 20). Alternatively, for example, the music-following light distribution control process may be ended at a time point when the music-following light distribution control process is stopped by control software that operates on the control device 300 or 300a, or for example, by an interface circuit provided in the speaker device 400a or the illumination device 1a or 1c.

The preferable embodiments of the present disclosure are described above, but the present disclosure is not limited to the embodiments. Contents disclosed in the embodiments are merely exemplary and may be modified in various kinds of manners without departing from the scope of the present disclosure. For example, in a case where an illumination device of the present disclosure is capable of adjusting not only the light distribution shape but also brightness and light color, the configuration of the present disclosure may be used to adjust the brightness and light color. Appropriate modifications made without departing from the scope of the present disclosure naturally belong to the technical scope of the present disclosure.

What is claimed is:

1. An illumination system comprising:
a speaker device capable of playing music data;
an illumination device capable of controlling a light distribution state of light emitted from a light source; and
a control device configured to transmit the music data to the speaker device and dynamically control the light distribution state of the illumination device in synchronization with a time-series change of the music data.

2. The illumination system according to claim 1, wherein the control device generates light distribution data for controlling the light distribution state of the illumination device based on a representative value of a data value of the music data in each first period obtained by dividing a music data length into a plurality of first periods.

3. The illumination system according to claim 2, wherein
when a median value of data values in a predetermined first period is larger than an average value of data values in a second period longer than the first period, the control device is configured to set a maximum value of the data values in the first period as the representative value, and
when the median value of the data values in the first period is equal to or smaller than the average value of the data values in the second period, the control device is configured to set a minimum value of the data values in the first period as the representative value.

4. The illumination system according to claim 2, wherein
the control device is configured to use, as the first period, an inter-beat interval detected based on periodicity of the music data,
when a median value of data values in the first period is larger than an average value of all data values of the music data, the control device is configured to set a maximum value of the data values in the first period as the representative value, and
when the median value of the data values in the first period is equal to or smaller than the average value of all data values of the music data, the control device is configured to set a minimum value of the data values in the first period as the representative value.

5. The illumination system according to claim 2, wherein
the control device is configured to use, as the first period, an inter-beat interval detected based on periodicity of the music data,
the control device is configured to set, as a representative value in a first half period of the first period, a minimum value among data values in the first period, and
the control device is configured to set, as a representative value in a second half period of the first period, a maximum value among the data values in the first period.

6. The illumination system according to claim 2, wherein
the control device is configured to use, as the first period, an inter-beat interval detected based on periodicity of the music data,
the control device is configured to set a first data value in the first period as a representative value in a first half period of the first period,
when the first data value in the first period is equal to or smaller than an average value of all data values of the music data, the control device is configured to set, as a representative value in a second half period of the first period, a maximum value among a plurality of data values in the first period, and
when the first data value in the first period is larger than the average value of all data values of the music data, the control device is configured to set, as a representative value in a second half period of the first period, a minimum value among the data values in the first period.

7. The illumination system according to claim 2, wherein the illumination device is configured to interpolate the light distribution data and perform dynamic light distribution control synchronized with a time-series change of the music data.

8. An illumination system comprising:
an illumination device capable of controlling a light distribution state of light emitted from a light source; and
a control device configured to control the light distribution state of the illumination device, wherein
the illumination device includes a speaker configured to play music data transmitted from the control device, and
the control device transmits the music data to the illumination device and dynamically controls the light distribution state of the illumination device in synchronization with a time-series change of the music data.

9. The illumination system according to claim 8, wherein the control device generates light distribution data for controlling the light distribution state of the illumination device based on a representative value of a data value of the music data in each first period obtained by dividing a music data length into a plurality of first periods.

10. The illumination system according to claim 9, wherein
when a median value of data values in a predetermined first period is larger than an average value of data values in a second period longer than the first period, the control device is configured to set a maximum value of the data values in the first period as the representative value, and
when the median value of the data values in the first period is equal to or smaller than the average value of the data values in the second period, the control device is configured to set a minimum value of the data values in the first period as the representative value.

11. The illumination system according to claim 9, wherein
the control device is configured to use, as the first period, an inter-beat interval detected based on periodicity of the music data,
when a median value of data values in the first period is larger than an average value of all data values of the music data, the control device is configured to set a maximum value of the data values in the first period as the representative value, and
when the median value of the data values in the first period is equal to or smaller than the average value of all data values of the music data, the control device is configured to set a minimum value of the data values in the first period as the representative value.

12. The illumination system according to claim 9, wherein
the control device is configured to use, as the first period, an inter-beat interval detected based on periodicity of the music data,
the control device is configured to set, as a representative value in a first half period of the first period, a minimum value among data values in the first period, and
the control device is configured to set, as a representative value in a second half period of the first period, a maximum value among the data values in the first period.

13. The illumination system according to claim 9, wherein
the control device is configured to use, as the first period, an inter-beat interval detected based on periodicity of the music data,
the control device is configured to set a first data value in the first period as a representative value in a first half period of the first period,
when the first data value in the first period is equal to or smaller than an average value of all data values of the music data, the control device is configured to set, as a representative value in a second half period of the first period, a maximum value among a plurality of data values in the first period, and
when the first data value in the first period is larger than the average value of all data values of the music data, the control device is configured to set, as a representative value in a second half period of the first period, a minimum value among the data values in the first period.

14. The illumination system according to claim 9, wherein the illumination device is configured to interpolate the light distribution data and perform dynamic light distribution control synchronized with a time-series change of the music data.

15. An illumination system comprising:
an illumination device capable of controlling a light distribution state of light emitted from a light source; and
a control device configured to play music data and dynamically control the light distribution state of the illumination device in synchronization with a time-series change of the music data.

16. The illumination system according to claim 15, wherein the control device generates light distribution data for controlling the light distribution state of the illumination device based on a representative value of a data value of the music data in each first period obtained by dividing a music data length into a plurality of first periods.

17. The illumination system according to claim 16, wherein
when a median value of data values in a predetermined first period is larger than an average value of data values in a second period longer than the first period, the control device is configured to set a maximum value of the data values in the first period as the representative value, and
when the median value of the data values in the first period is equal to or smaller than the average value of the data values in the second period, the control device is configured to set a minimum value of the data values in the first period as the representative value.

18. The illumination system according to claim 16, wherein
the control device is configured to use, as the first period, an inter-beat interval detected based on periodicity of the music data,
when a median value of data values in the first period is larger than an average value of all data values of the music data, the control device is configured to set a maximum value of the data values in the first period as the representative value, and
when the median value of the data values in the first period is equal to or smaller than the average value of all data values of the music data, the control device is configured to set a minimum value of the data values in the first period as the representative value.

19. The illumination system according to claim 16, wherein
the control device is configured to use, as the first period, an inter-beat interval detected based on periodicity of the music data,
the control device is configured to set, as a representative value in a first half period of the first period, a minimum value among data values in the first period, and
the control device is configured to set, as a representative value in a second half period of the first period, a maximum value among the data values in the first period.

20. The illumination system according to claim 16, wherein
the control device is configured to use, as the first period, an inter-beat interval detected based on periodicity of the music data,
the control device is configured to set a first data value in the first period as a representative value in a first half period of the first period,
when the first data value in the first period is equal to or smaller than an average value of all data values of the music data, the control device is configured to set, as a representative value in a second half period of the first period, a maximum value among a plurality of data values in the first period, and
when the first data value in the first period is larger than the average value of all data values of the music data, the control device is configured to set, as a representative value in a second half period of the first period, a minimum value among the data values in the first period.
